(19) United States
(12) Patent Application Publication
(10) Pub. No.: US 2026/0080102 A1
(43) Pub. Date: Mar. 19, 2026

(54) Large Byte Model

(71) Applicant: CrowdStrike, Inc., Sunnyvale, CA (US)

(72) Inventors: FLORIAN MICHAEL STÖRTZ, London (GB); Alexandru Dinu, Bucharest (RO); Ioana Croitoru, Bucharest (RO); Mihaela-Petruta Gaman, Bucharest (RO)

(73) Assignee: CrowdStrike, Inc., Sunnyvale, CA (US)

(21) Appl. No.: 18/884,477

(22) Filed: Sep. 13, 2024

(51) Int. Cl. G06F 21/64; G06F 40/284

(52) U.S. Cl. CPC G06F 21/64; G06F 40/284

(57) ABSTRACT

A cloud-based service assesses sequences of bits/bytes in natural language using a large byte model representing a large language model trained using a byte vocabulary expansion. The byte vocabulary expansion allows the large language model's textual vocabulary to also include byte-related information associated with different sequences of bits/bytes (e.g., 1's and 0's). The large byte model may thus be given a binary input, and optionally a textual instruction, and the large byte model generates simple natural language descriptions explaining/describing binary input.

### BACKGROUND

The subject matter described herein generally relates to computers, to artificial intelligence and to computer security and, more particularly, the subject matter relates to binary analysis and to natural language processing.

Binary data is exceptionally difficult to analyze. In most industries, long strings of bytes (e.g., 1's and 0's) must be analyzed to understand how software and computers are behaving. Inspecting and understanding long strings of binary data, though, is very tedious and requires great expertise. Binary analysis, for example, is a key effort in cybersecurity services. Cybersecurity service providers must often delve deep into binary data. These binary formats represent the bread and butter of cyber attackers, and some of the most dangerous malware behaviors are hidden in executable files. Needless to say, inspection and assessment of binary data requires specialized expertise and it can be extremely time consuming. As the volume and complexity of cybersecurity threats is always increasing, cybersecurity service providers need faster tools that adapt to new threats.

### SUMMARY

A large byte model revolutionizes binary analysis. The large byte model is a computer tool that greatly simplifies and explains long strings of binary data. The large byte model, for example, may be given multi-modal inputs (such as sequences of binary data and natural language context or questions). The large byte model then generates a natural language output. The natural language output, for example, provides a simple description and explanation of the inputted sequences of binary data. The large byte model, in other words, explains the semantics of very complicated bits and bytes using generalized words and phrases that are far easier for human users to understand. Indeed, human users may ask specific questions regarding the inputted binary data, and the large byte model generates answers using natural language. The large byte model greatly simplifies binary analysis and may be implemented to summarize and explain binary data, regardless of industry.

The large byte model is trained to understand and explain binary content. The large byte model represents a large language model that is trained using a byte vocabulary expansion. The large byte model, in other words, has a large language vocabulary (such as English) that is expanded to include tokens composed of byte sequences. The large byte model expands the vocabulary of the large language model from raw English (sub)words to also contain byte info. A byte token, for example, is a binary sequence in the same way an English token represents a sequence of characters in English (as later paragraphs explain). The large byte model may thus relate sequences of bytes to their corresponding natural language explanations. The large byte model may be queried in a similar way as a large language model, although the large byte model also has an extensive knowledge of byte content. The large byte model may thus accept multi-modal inputs (such as text+bytes), and the large byte model may generate multi-modal outputs (i.e., text+bytes). The large byte model revolutionizes binary assessment.

As an example, the large byte model simplifies cybersecurity services. The large byte model may be asked to explain a string of bytes that has been flagged as suspicious. The large byte model may thus generate a simple, natural language summary of binary semantics, activities, and computer behavior caused by the string of bytes. The large byte model may further describe the string of bytes, such as which malware family it belongs to other attributions. The large byte model may thus support detection of malware and other cybersecurity threats. The large byte model, however, may also be implemented as a training and educational tool for binary content. The large byte model helps human users, and downstream services, understand binary specifics and behavior. Moreover, the large byte model may also help threat analysts quickly write binary analysis reports. The large byte model is a versatile tool having wide and diverse capabilities for both specialized and non-specialized uses.

### BRIEF DESCRIPTION OF THE SEVERAL VIEWS OF THE DRAWINGS

The features, aspects, and advantages of the large byte model are understood when the following Detailed Description is read with reference to the accompanying drawings, wherein:

FIGS. 1-3 illustrate some examples of assessing cybersecurity events reported by clients;

FIG. 4 illustrates some examples of model/modal inputs;

FIGS. 5-7 illustrate some examples of tokenization;

FIG. 8 illustrates the bimodal structure of the large byte model;

FIG. 9 illustrates the optimization of the token set and the initialization of their embeddings as a precursor to training of the large byte model;

FIG. 10-11 illustrates the three main steps of large byte model training;

FIGS. 12-13 illustrate some examples of true and false positives;

FIGS. 14-15 illustrate some examples of cybersecurity binary data;

FIG. 16 illustrates more detailed examples of cybersecurity events;

FIG. 17 illustrates some examples of remote access;

FIG. 18 illustrates some examples of local analysis;

FIG. 19 illustrates some examples of other particular solutions to particular problems;

FIGS. 20-21 illustrate examples of methods or operations that assess bits/bytes/sequences/files; and

FIG. 22 illustrates a more detailed example of an operating environment.

### DETAILED DESCRIPTION

Some examples relate to binary analysis. Our smartphones, laptops, and other computers download and store software. The software is converted to binary data (e.g., 1's and 0's), and the binary data instructs the computer how to perform. Oftentimes, though, long strings of 1's and 0's must be analyzed to understand how the software is causing the computer to behave. Inspecting and understanding long strings of binary data is exceptionally difficult.

A large byte model, though, revolutionizes the binary analysis of 1's and 0's. The large byte model is a computer program that generates interpretations of long strings of binary data. A human user, for example, merely provides the binary data as an input to the large byte model. The human user may also type a question (such as “summarize this binary data”). The large byte model then generates a natural language output that answers the user's question. The natural language output, for example, provides a description and explanation of the inputted binary data. The large byte model, for example, explains the 1's and 0's using natural language, such as generalized words and phrases that are far easier for humans to understand. The human user, of course, may also ask very specific questions regarding the binary data, and the large byte model again generates specific answers using natural language. The large byte model thus provides fast, simple, and revolutionary techniques for interpreting complex binary data.

The large byte model uses generative artificial intelligence. The large byte model may include a large language model that is trained using a byte vocabulary expansion. The large byte model, for example, has a large English language vocabulary, but the English vocabulary is expanded to explain different sequences of binary 1's and 0's. The large byte model may thus include natural language statements that describe sequences of bytes. The large byte model may thus accept multi-modal inputs (such as text+bytes), and the large byte model may generate multi-modal outputs (i.e., text+bytes). Users may ask questions regarding binary data, and the large byte model generates plain, easy to understand answers. The large byte model thus represents a large language model that has been elegantly trained to include an extensive knowledge of binary data. The large byte model thus accepts strings and sequences of bits and bytes and generates simple, easy-to-understand natural language explanations. The large byte model, in other words, is able to explain very complicated byte-based inputs using generalized words and phrases that are far easier to understand. The large byte model revolutionizes the assessment of complex binary data.

The large byte model, as an example, may be implemented in cybersecurity services. Cybersecurity services analyze strings of complex binary data to understand computer behavior. Cybersecurity services may thus use the large byte model to explain complex binary data, and computer behavior, in simple, everyday words and phrases. The large byte model provides reasons why a byte content is causing a specific computer behavior. Cybersecurity services may further use the large byte model as a training and educational tool for understanding and explaining byte content. Via an appropriate prompt (such as a text instruction, for example), one possible use case for the large byte model is to assess whether byte content is malicious or benign and to provide a natural language description of the computer behavior. The cybersecurity service may thus use the large byte model when detecting the presence of malicious computer activities, behaviors, and contexts in the 1's and 0's. Moreover, when the large byte model is fed a sequence of bytes, the large byte model may also predict the next 1's and 0's in the sequence. Through being trained in an autoregressive manner, i.e. by predicting next bytes and comparing them to the real next bytes, the large byte model learns about the structure of binary files. By additionally providing context (such as malware families and behaviors), the large byte model also learns to attribute these byte structures to real world phenomena and reason about them in text form. The cybersecurity service may thus use the large byte model to elegantly generate quick cybersecurity predictions and explanations for much faster detection and assessment of cybersecurity threats. The large byte model helps human users, and downstream services, understand binary specifics and behavior. Moreover, the large byte model may also help threat analysts quickly write binary analysis reports. The large byte model is a versatile tool having wide and diverse capabilities for both specialized and non-specialized uses.

The large byte model, however, may be easily adapted to other use cases. The large byte model may be trained and implemented to interpret and explain/reason about other byte content. The large byte model, for example, may interpret and explain gaming byte content, industrial/manufacturing/machining byte content, science/technical/engineering/computer byte content, biological/pharma/medical byte content, and accounting/business/finance byte content. Whatever the byte content, the large byte model thus retains the linguistic reasoning capabilities of the base large language model while also enabling the large language model to reason about byte data.

The large byte model will now be described more fully hereinafter with reference to the accompanying drawings. The large byte model, however, may be embodied in many different forms and should not be construed as limited to the examples set forth herein. These examples are provided so that this disclosure will be thorough and complete and fully convey the large byte model to those of ordinary skill in the art. Moreover, all the examples of the large byte model are intended to encompass both structural and functional equivalents thereof. Additionally, it is intended that such equivalents include both currently known equivalents as well as equivalents developed in the future (i.e., any elements developed that perform the same function, regardless of structure).

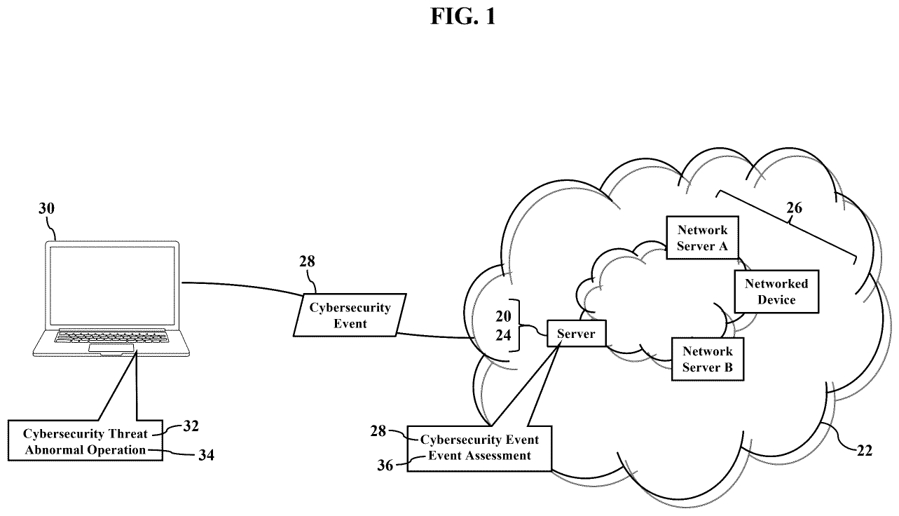

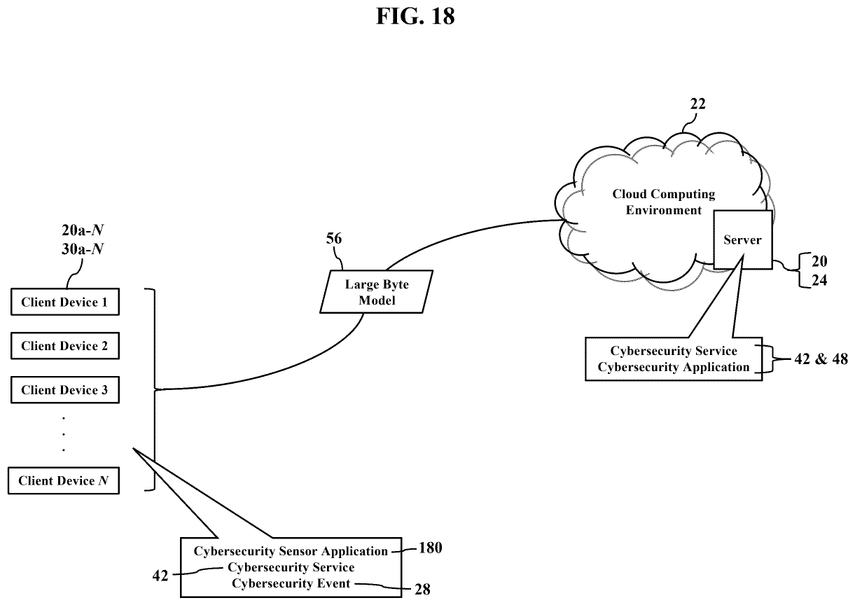

FIGS. 1-3 illustrate some examples of assessing cybersecurity events reported by clients. FIG. 1 illustrates a computer system 20 operating in a cloud computing environment 22. The computer system 20, though, may implement a local solution (which later paragraphs will explain with reference to FIG. 18). FIG. 1 illustrates the computer system 20 as a server 24. The computer system 20, though, may be any processor-controlled device, as later paragraphs will explain. In this example, the server 24 communicates via the cloud computing environment 22 (e.g., public Internet, private network, and/or hybrid network) with other servers, devices, computers, or other networked members 26 operating within, or affiliated with, the cloud computing environment 22. The server 24 is programmed to pre-screen or assess cybersecurity events 28 reported by a client device 30. That is, when the client device 30 detects suspicious/unknown behavior, suspicious/unknown activity, unusual login/location context, or other potential cybersecurity threat 32 (as later paragraphs will explain in greater detail), the client device 30 sends the cybersecurity event(s) 28 to the cloud computing environment 22. The cybersecurity event 28 alerts or notifies the cloud computing environment 22 that the client device 30 has detected the potential cybersecurity threat 32. The client device 30, in other words, has detected a program, process, communication, behavior, location, or some other evidence that may indicate abnormal operation 34 (such as suspicious/malicious behavior, usage, or software/malware). The client device 30 may then notify the cloud computing environment 22 for a fuller, more detailed event assessment 36.

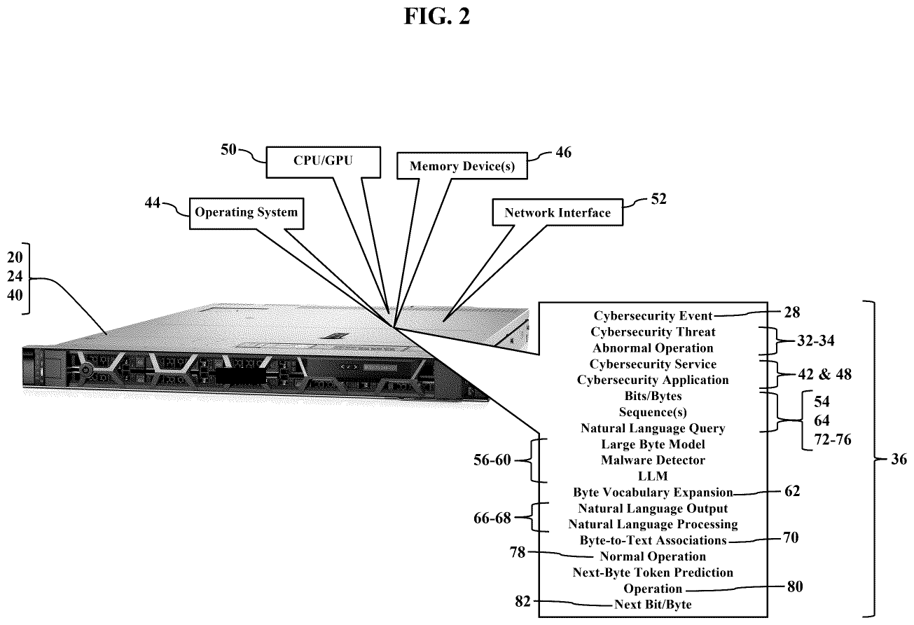

FIG. 2 illustrates some examples of the event assessment 36. When the cloud computing environment 22 (illustrated in FIG. 1) receives the cybersecurity event 28, the cloud computing environment 22 analyzes the cybersecurity event 28. While the cybersecurity event 28 may be analyzed by the networked members 26 (illustrated in FIG. 1), FIG. 2 illustrates a simple example using the server 24. When the cloud computing environment 22 receives the cybersecurity event 28, the networked members 26 may route the cybersecurity event 28 to the server 24 for the event assessment 36. FIG. 2 illustrates the server 24 as a rack server 40, which is commonly installed in server rooms and in server farms. The server 24/40 is programmed to assess the cybersecurity event 28 and to perhaps even predict whether the cybersecurity event 28 is the cybersecurity threat 32 and/or the abnormal operation 34. The server 24/40 may thus provide a cloud-based digital cybersecurity service 42. The server 24/40 stores and executes an operating system 44 in a memory device 46. The server 24/40 also stores a cybersecurity application 48 in the memory device 46. The server 24/40 has a hardware processor with cores 50 (illustrated as “CPU/GPU”) that reads and executes the operating system 44 and the cybersecurity application 48. The server 24/40 also has network interfaces 52 to multiple communications networks (such as the cloud computing environment 22 illustrated in FIG. 1), thus allowing bi-directional communications with other networked devices and services. When the server 24/40 receives the cybersecurity event 28, the cybersecurity application 48 may be a computer program, instruction(s), or code that instructs or causes the server 24 to preliminarily assess the cybersecurity event 28.

The server 24/40 performs the fast and effective cybersecurity service 42. When the server 24/40 receives the cybersecurity event 28, the server 24/40 executes the cybersecurity application 48, perhaps as a prediction engine. The cybersecurity application 48, as an example, instructs or causes the hardware processor 50 to perform operations, such as retrieving or otherwise acquiring the raw binary data 54 (e.g., 1's and/or 0's) associated with the cybersecurity event 28. The server 24 may ingest the binary bits/bytes 54 as an input, and the cybersecurity application 48 instructs the server 24 to perform more operations, such as utilizing the large byte model 56 as a malware detector 58. The large byte model 56 represents a large language model (or LLM) 60 that is trained using a byte vocabulary expansion 62. The large byte model 56, in other words, accepts the raw bits/bytes 54 (e.g., 1's and/or 0's) as an input prompt 64 and builds or generates a natural language output 66. The natural language output 66 explains or describes the semantics and/or domain context surrounding the raw bits/bytes 54 using natural language processing 68. The cybersecurity service 42 may thus generate the large byte model 56 by extending the large language model 60 using byte-to-text associations 70. A user of the cybersecurity service 42 may even input a multi-modal input prompt 72 (such as sequence(s) 74 of the bits/bytes 54 and an audible/textual natural language query 76) and receive an answer, explanation, or other natural language output 66. The large byte model 56, in particular, may identify and detect whether the sequence(s) 74 of the bits/bytes 54 is/are normal operation 78 or suspicious/malicious binary data (e.g., the abnormal operation 34). Indeed, the large byte model 56 may also implement a next-byte token prediction operation 80 to predict a next bit/byte 82 in the sequence 74 of 1's and 0's (as later paragraphs will explain).

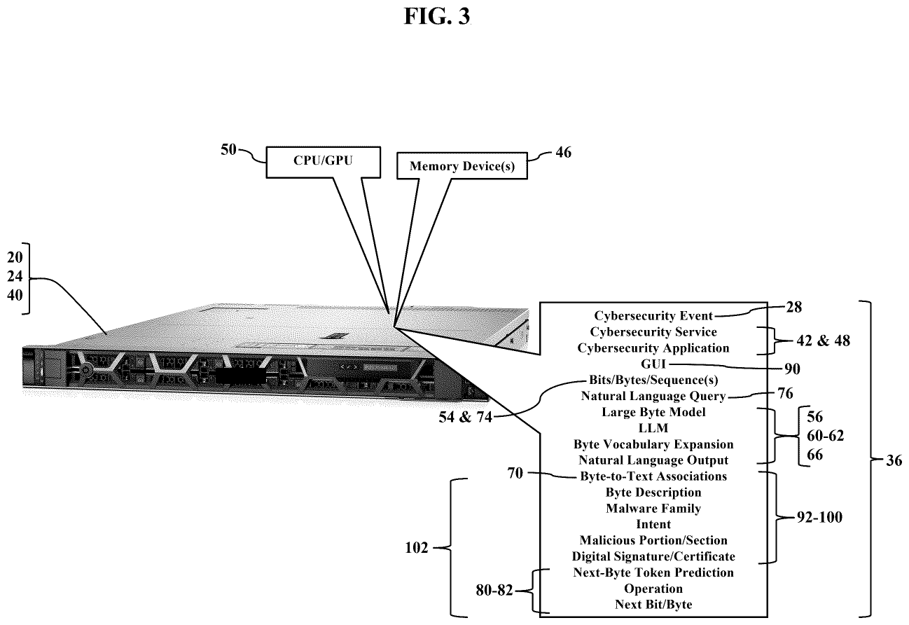

FIG. 3 illustrates some examples of the natural language output 66. The large byte model 56 melds or harnesses generative artificial intelligence to describe or explain the sequence(s) 74 of the 1's and 0's (bits/bytes 54). The cybersecurity service 42, the cybersecurity application 48, and/or the large byte model 56 has/have a graphical user interface (or GUI) 90 for ease of use (as later explained with reference to FIG. 18). The user of the cybersecurity service 42 merely accesses the server 24 (again illustrated as the rack server 40) and uses the graphical user interface 90 to enter, input, select, copy/paste, or otherwise identify the byte sequences of concern. The user may also type, speak, or otherwise input her/his natural language query 76. The cybersecurity service 42 may then use the large byte model 56 to generate the natural language output 66. The cybersecurity service 42, as examples, may generate a byte description 92 that is displayed or otherwise presented by the graphical user interface 90. The byte description 92 describes the bits/bytes/sequence 54/74 (such as one or more of the byte-to-text associations 70), perhaps albeit using the simple, easily understood natural language output 66. The cybersecurity service 42 may even answer specific questions, such as identifying a malware family 94 associated with the 1's and 0's and/or identifying an intent 96 associated with the 1's and 0's. The cybersecurity service 42 may highlight/emphasize/identify a malicious portion/section 98 of the 1's and 0's. The cybersecurity service 42 may further specify whether the 1's and 0's are associated with a digital signature/certificate 100. The cybersecurity service 42 may thus process the raw bits/bytes/sequences 54/74, along with the natural language queries 76, and generate the natural language output 66 explaining the byte description 92 and even the predicted next bit/byte 82.

The cybersecurity service 42, implementing the large byte model 56, keeps pace with evolving malware. Cyber attackers are constantly evolving and obfuscating their malicious schemes. Legitimate software services are also constantly evolving. The cybersecurity industry is thus always striving to improve threat detection in a very dynamic environment. Binary formats (e.g., the 1's and 0's) represent the bread and butter of cyber attackers as, to date, some of the most dangerous and well spread types of malware come from executable files. With the ever-growing pace at which new malware families 92 emerge, traditional cybersecurity solutions often fail to generalize. In these cases, adapting amounts to updating the heuristics and models, after a thorough expert-driven analysis of the problematic cybersecurity threats 32. The cybersecurity service 42, though, shifts how the unknown is regarded, by leveraging the large language model 60 to reduce the manual work involved in analyzing and detecting new malicious behaviors in executables. The large byte model 56 is thus an LLM-inspired technique for binary formats, which may be trained (perhaps using the byte-to-text associations 70 and/or the next-byte token prediction operation 80) and fine-tuned to address use-cases similar to how an LLM trained on textual data would perform.

The cybersecurity service 42 thus harnesses the power of the latest generative AI technologies. The cybersecurity service 42 also harnesses the unique properties and high quality of large byte quantities of cybersecurity binary data 102 (such as the byte-to-text associations 70, malware family 92, and bit/byte/sequence program intent 94, as FIG. 3 illustrates). This cybersecurity binary data 102 (potentially a massive amount, such as perhaps daily petabytes) may be labeled or categorized (such as the byte-to-text associations 70 describing normal operation 78 or the suspicious/maliciousness/abnormal operation 34, as later paragraphs explain). The cybersecurity service 42 trains the large byte model 56 using large data sets of multi-modal content, including natural language, images, audio and the cybersecurity binary data 102 as the byte vocabulary expansion 62. The cybersecurity service 42 (using the large byte model 56) may thus use patterns identified in the training data to produce new, statistically similar content (such as the natural language output 66 and/or the predicted next bit/byte 82). The cybersecurity service 42 may thus build atop the knowledge that an open-source LLM already has in generating human-like language and aims to integrate byte data (e.g., the bits/bytes/sequences 54/74) as another modality. The cybersecurity service 42 thus implements the byte vocabulary expansion 62 to train the large byte model 56 using the large amounts of labeled and/or unlabeled cybersecurity binary data 102.

The cybersecurity service 42 leverages the large language model 60. The large language model 60 may understand and output whatever language(s) is/are desired (e.g., German, French, Spanish, Romanian, Italian, and others), however current LLMs have limited knowledge of binary data. The cybersecurity service 42, for example, may build the large language model 60 from scratch using a corpus of words, characters, phrases, and punctuation. While the scratch-built large language model 60 may include whatever custom/specialized terminology is desired, scratch-built LLMs may be time, labor, and cost prohibitive. The cybersecurity service 42, instead, may be cost-effective and piggy-back on existing or developing open-source LLM architectures. The cybersecurity service 42 may thus incorporate an existing or open source LLM, and generally, most existing LLMs have a good command of English. Whatever the large language model 60, the cybersecurity service 42 expands or increases the context to incorporate the bits/bytes/sequences 54/74 (e.g., the byte vocabulary expansion 62). The large byte model 56 enhances the large language model 60 to accept the multi-modal input prompt 72 and ingest the binary data (such as the bits/bytes 54 illustrated in FIG. 2) as another modality. The large byte model 56 processes the binary data more efficiently than the large language model 60, also the large language model 60 has very limited knowledge of binary data. Thus, in some examples, the cybersecurity service 42 may implement the byte vocabulary expansion 62 as a continual pre-training setup that takes advantage of the knowledge of pre-trained open-source LLMs, while improving this knowledge with the ability to read and to understand binary formats (e.g., 1's and 0's).

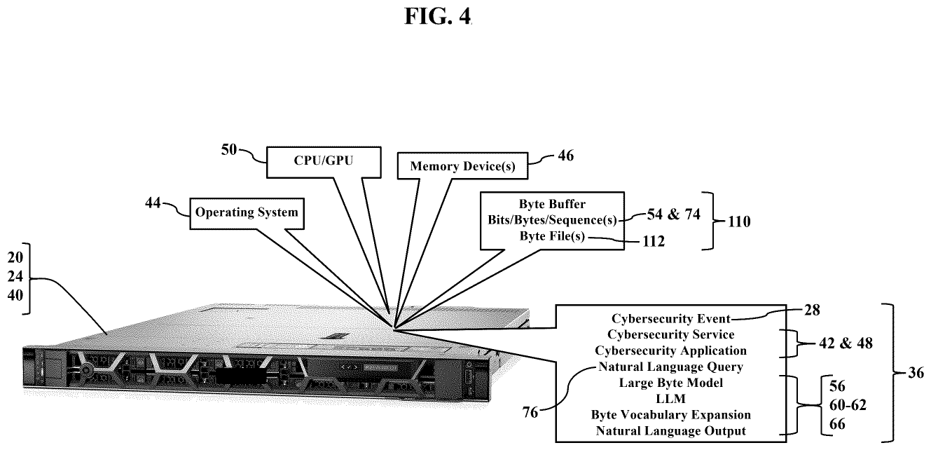

FIG. 4 illustrates more examples of model/modal inputs. The user of the cybersecurity service 42 may merely specify the bits/bytes/sequence 54/74 (1's and 0's) of concern. The user, however, may also include the textual/audible natural language query 76 (e.g., the multi-modal input prompt 72, as best illustrated by FIG. 2). Although not shown, the user may speak his/her natural language query 76, and a speech-to-text system may convert/translate the user's spoken natural language query 76 into textual input. Regardless, the 1's and 0's may be too tedious and cumbersome for human input (whether by manual input or cut-n-paste). The sequence 74 of 1's and 0's, for example, may commonly contain thousands, millions, or even more of digital/binary characters. The cybersecurity service 42 may thus utilize a byte buffer 110 as an input prompt mechanism. The cybersecurity application 48 may cooperate with the operating system 44 to establish and configure the byte buffer 110 in the memory device 46. The byte buffer 110 may be dedicated to the cybersecurity service 42, the cybersecurity application 48, and/or the large byte model 56 for storing the bits/bytes/sequences 54/74 referenced by the natural language query 76. The cybersecurity application 48 may then collect and write the thousands or millions of 1's and 0's to the byte buffer 110 as a streaming content container. Indeed, the byte buffer 110 may even be sized to accept and store megabytes of digital/binary data (such as one or more executable byte files 112). The user of the cybersecurity service 42 may thus merely select the byte file 112 of concern, and the cybersecurity application 48 may then collect and write the 1's and 0's representing the byte file 112 to the byte buffer 110. The cybersecurity application 48 may then cooperate with the operating system 44 to sequentially read and feed the contents of the byte buffer 110 into the large byte model 56 for processing and analysis.

Stopping malware through the large byte model greatly improves computer functioning. The server 24/40 takes advantage of the knowledge of pre-trained proprietary, customer, and/or open-source LLMs, while improving this textual knowledge with the ability to read and to understand binary formats. The cybersecurity application 48 programs the server 24/40 to quickly and simply detect malicious intent in binary data (e.g., the 1's and 0's written and stored to the byte buffer 110). The cybersecurity application 48, however, also programs the server 24/40 to ingest textual/spoken/audible natural language queries 76 and to generate textual/spoken/audible replies (e.g., the natural language output 66). The server 24, in plain words, identifies and detects cyberthreats in a more accurate and flexible manner than conventional rules-based malware detection schemes. The server 24/40, by implementing the large byte model 56, attains an inherent, deep understanding of byte files, and the server 24/40 generates the helpful natural language output 66.

The inventors may custom tailor the large language model 60 for working with binary data. The bits/bytes/sequence 54/74 (perhaps written and stored to the byte buffer 110) may be large byte files 112 (i.e., executables, libraries, object code, and others), hence the large byte model 56. The results of the large byte model 56 (such as the natural language output 66 and/or the predicted next byte 82) may thus be used as further inputs to downstream tasks/systems, such as classification, extracting the malicious byte content, explaining the cybersecurity event 28, and metadata attribution (such as the malware family and/or the MITRE TTPs). The inventors train the large byte model 56 using the raw bits/bytes/sequence 54/74 and without using an intermediate representation like disassembled/decompiled code. The inventors control the model architecture, data composition, pre-training, and fine-tuning tasks.

The inventors have thus designed, built, and trained the large byte model 56 for a particular solution to a particular problem. Malware is a problem in computing systems and in computer networks. As we all know, nearly every day there is another hack that steals account passwords, business data, and personal information. Email inboxes often contain phishing emails, malicious website links, and virus attachments. Text messages may also contain malicious links and content. Indeed, hackers are always trying new schemes to steal information. The cybersecurity service 42, though, customizes and tailors the large language model 60 as the large byte model 56 to particularly detect or predict malware. The large byte model 56, in particular, identifies and describes/explains raw 1's and 0's represent suspicious/maliciousness/abnormal operation 34. The inventors have designed, built, and trained the large byte model 56 as a significant contribution to binary malware detection and to natural language explanation of binary semantics.

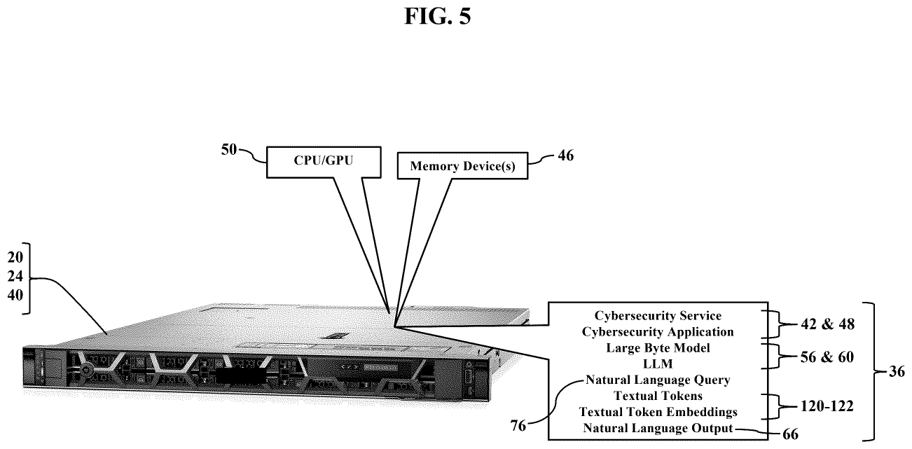

FIGS. 5-7 illustrate some examples of tokenization. The cybersecurity application 48 may instruct or cause the server 24 (again illustrated as the rack server 40) to perform operations for generating textual tokens 120. The large byte model 56, representing the large language model 60, may then be trained using the textual tokens 120. Tokenization of textual inputs (such as the natural language query 76) is known and need only be simply explained. The textual tokens 120 represent words, character sets, or combinations of words and punctuation. The large byte model 56 may tokenize textual training data and analyze patterns and semantic relationships between tokens. After training, the large byte model 56 may use those patterns and relationships to generate a sequence of output tokens based on the input sequence (representing the natural language query 76). The large byte model 56 may use a tokenization scheme or method, such as word tokenization, character tokenization, and subword tokenization, byte-pair encoding, and others as desired. The large byte model 56 may assign a unique textual token identifier to each textual token 120. The large byte model 56 may thus represent the natural language query 76 as a sequence of textual token identifiers. The large byte model 56 may then generate textual token embeddings 122 (using the textual token identifiers) that represent the semantic relationships between the textual tokens 120. Each textual token embedding 122 is assigned to a corresponding one of the textual tokens 120, for example, based on how commonly the corresponding textual token 120 is used together with, or in similar contexts to, the other textual tokens 120. After the large byte model 56 is trained, the large byte model 56 uses the learned textual token embeddings 122 to iteratively generate the natural language output 66.

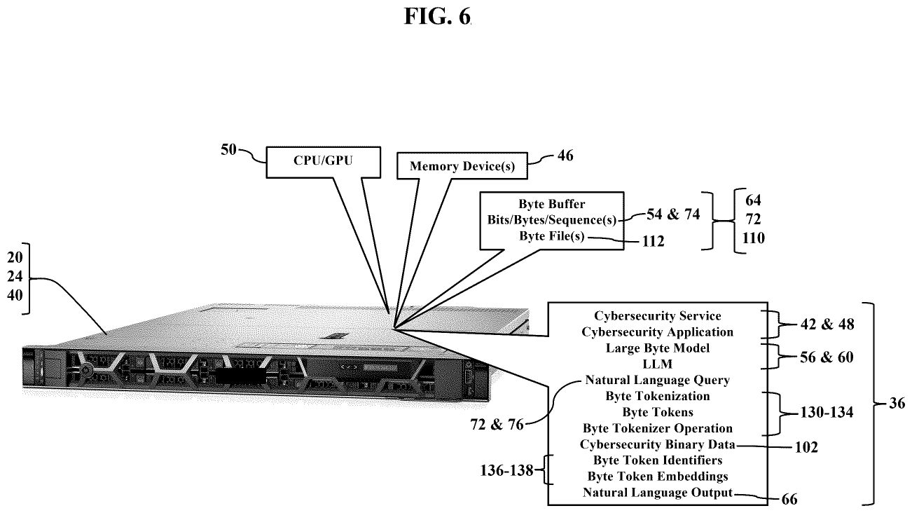

FIG. 6, though, illustrates byte tokenization 130. Many large language models have limitations regarding the maximum number of tokens that can be used as input or generated as output (or combined into a maximum context window or size). Recall, though, that the multi-modal input prompt 72 may include both the textual/audible natural language query 76 and the many hundreds, thousands, or millions of input bytes (perhaps written to the byte buffer 110). Simply put, the multi-modal input prompt 72 may greatly exceed the maximum context window or size associated with large language models. The cybersecurity service 42, though, may implement the elegant byte tokenization 130 to fit more binary data into the context window or size associated with large language models. The cybersecurity service 42, additionally or alternatively, may implement the elegant byte tokenization 130 to increase the representational density of the binary data via specialized byte tokens 132, as below explained.

The large byte model 56 may generate byte tokens 132. The cybersecurity application 48 may cause or instruct the server 24 to perform a byte tokenizer operation 134 that tokenizes the bits/bytes/sequences 54/74 specified by the input prompt 64 and/or by the multi-modal input prompt 72. The byte tokenizer operation 134 allows the large byte model 56 to process long strings of the raw 1's and 0's (such as the large, executable byte file(s) 112 written/stored to the byte buffer 110). The byte tokenizer operation 134 causes the server 24 to generate one or more of the byte tokens 132, perhaps depending on the byte size of the raw bits/bytes/sequences 54/74. The byte tokens 132 may have equal or unequal byte sizes or byte lengths. The large byte model 56 may thus be trained by applying the byte tokenizer operation 134 to the cybersecurity binary data 102. The cybersecurity binary data 102 (perhaps many petabytes) may be labeled or categorized (such as the byte-to-text associations 70 describing normal operation 78 or the suspicious/maliciousness/abnormal operation 34, as explained with reference to FIGS. 2-3). The byte tokens 132 represent different sequences 74 of 1's and 0's. The byte tokens 132, however, may also be associated with labels or categories (such as the normal/abnormal 78/34 classification and other byte-to-text associations 70). The large byte model 56 may analyze patterns and relationships between the byte tokens 132. After training, the large byte model 56 may use those patterns and relationships to generate a sequence of the byte tokens 132 based on the input bits/bytes/sequences 54/74. The large byte model 56 may assign a unique byte token identifier 136 to each byte token 132. The large byte model 56 may thus represent each sequence 74 of the 1's and 0's as a sequence of byte token identifiers 136. The large byte model 56 may then generate byte token embeddings 138 (using the byte token identifiers 136) that represent the patterns/relationships between the byte tokens 132. A byte token embedding 138 may thus be assigned to each corresponding byte token 132. After the large byte model 56 is trained, the large byte model 56 uses the learned byte token embeddings 138 to iteratively generate the natural language output 66.

The large byte model 56 may also generate strings of byte embeddings. Once the large byte model 56 is trained, the large byte model 56 may calculate the byte token embedding 138 for sequences of the byte tokens/identifiers 132/136. The large byte model 56 may thus tokenize long strings of bits/bytes/sequences 54/74 and calculate a string of byte embeddings values based on the learned byte token embeddings 138 of the individual byte tokens 132.

The cybersecurity service 42 expands a context window. The byte tokenizer operation 134 expands the context window associated with the large byte model 56. Many open source LLMs, for example, may have a context window length that ranges from around eight thousand (8K) tokens to 128 thousand tokens. Many byte files 122, though, may have megabytes of binary 1's and 0's, so many byte files 122 may greatly exceed the context window length. The byte tokenizer operation 134 thus allows the cybersecurity service 42 to extend the information density within the existing context window, by introducing bespoke byte tokens 132. With this higher information density, we can think of the byte tokenizer operation 134 as increasing the context window by a 2×, 3×, 4× factor; even increases by order(s) of magnitude may be available. The cybersecurity binary data 102, for example, may describe hundreds, thousands, or more of malicious files, and those files typically range from 1-10 megabytes. The cybersecurity service 42 may thus detect and predict many or most malicious binary data.

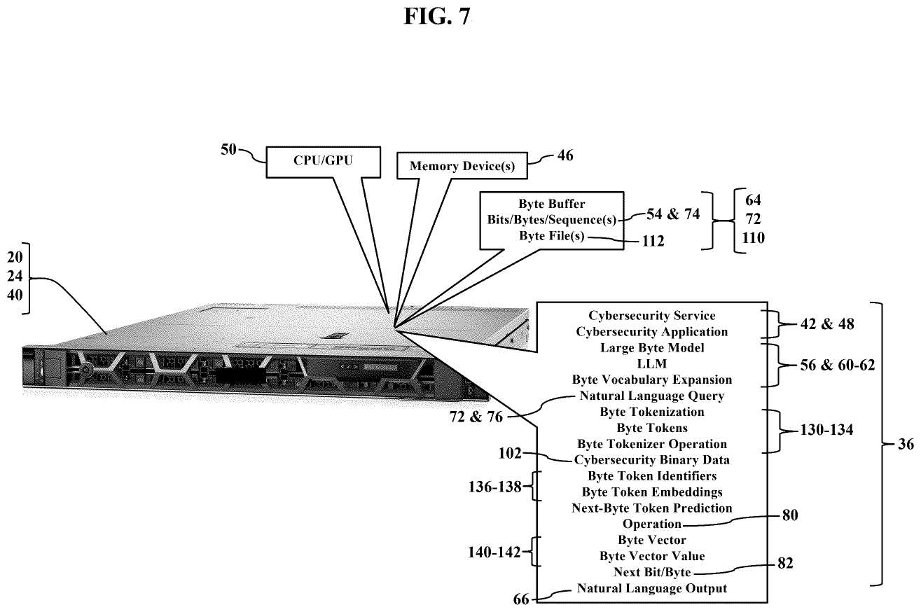

As FIG. 7 illustrates, the large byte model 56 may predict future bit content. Each byte token embedding 138 may be represented as a byte vector 140 having one or more byte vector values 142. The large byte model 56 may also use the learned byte token embeddings 138 in the next-byte token prediction operation 80, thus predicting the next token (whether a word token and/or the next byte token 132 as a bit/byte 82 in the sequence 74 of the 1's and 0's). During output generation, the large byte model 56 may predict a byte vector value 142 for the next byte token 132 in the sequence of the byte tokens/identifiers 132/136. The large byte model 56 may then select the next byte token 132 (such as from the byte vocabulary expansion 62) based on sampling from a distribution over all vocabulary tokens. The large byte model 56, for example, may calculate multiple byte vectors by using various elements of the previous byte tokens 132 and their byte token embeddings 138. The large byte model 56 may then evaluate all potential byte tokens 132 from these byte vectors and select the most probable byte token 132 to continue the sequence 74 of the 1's and 0's. The large byte model 56 may thus iteratively append the predicted byte token 132 as the next bit/byte 82 in the sequence 74. The large byte model 56 may then again iterate and use the predicted byte token 132 in the sequence 74 as the input for the next iteration. The large byte model 56 may thus continue predicting and building future/next bit/byte 82 in the sequence 74 as one byte token 132 at a time.

The byte vocabulary expansion 62 characteristic of an implementation of the large byte model 56 may also be enhanced with additional byte tokens 132 that better represent binary files. As cyber attackers evolve their schemes, the cybersecurity binary data 102 may be continually updated with new or refined byte-to-text associations 70 describing the normal operation 78 and/or the suspicious/maliciousness/abnormal operation 34 (as explained with reference to FIGS. 2-3). The large byte model 56 may thus be refined by continued training using new training bytes and their corresponding new byte tokens 132 and new byte token identifiers 136 that have been added to the byte vocabulary expansion 62. The large byte model 56 may thus grow and evolve as the cyber attackers evolve their malicious schemes.

The large byte model 56 is thus a specific solution to overcome the problem of malware detection. The large byte model 56 is a foundational generative AI model that aims to leverage the recent advances in the large language models space (e.g., the large language model 60) and apply the advances to binary data (such as portable execute files, Mach-O files, Executable and Linkable Format or EFF files, and other executable files). The large byte model 56, by natively adapting the large language model 60 to these and other file types using the byte vocabulary expansion 62, is able to reason about the cybersecurity events 28, identify and explain suspicious byte sequences 74 within a file, and explain the intent 96 of a binary and attribute it to various classes of interest (such as the malware families 94 and MITRE tactics). The large byte model 56, however, may be easily adapted to other use cases. The large byte model 56 may be trained and implemented to interpret and explain/reason about other byte content. The large byte model 56, for example, may interpret and explain gaming byte content, industrial/manufacturing/machining byte content, science/technical/engineering/computer byte content, biological/pharma/medical byte content, and accounting/business/finance byte content. Whatever the byte content, the large byte model 56 thus retains the linguistic reasoning capabilities of the base large language model 60 while also enabling the large language model 60 to reason about byte data.

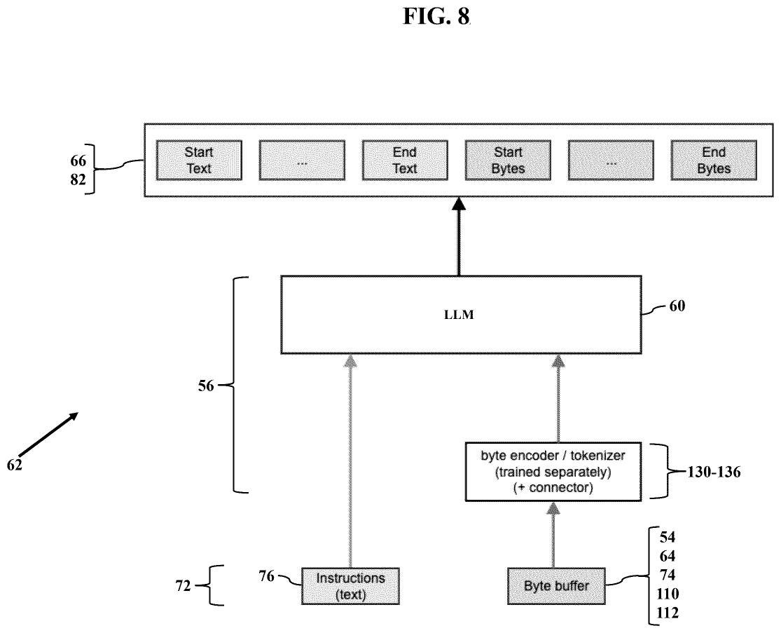

FIGS. 8-11 illustrate more examples of the byte vocabulary expansion 62. The byte vocabulary expansion 62 extends the vocabulary of the large language model 60 using the byte tokenizer operation 134. FIG. 8, for example, is a simple architectural illustration of the large byte model 56. The byte tokens 132, and their corresponding byte token identifiers 136, represent the unique sequences 74 of the 1's and 0's (e.g., the bits/bytes 54). The byte vocabulary expansion 62 thus allows the large byte model 56 to accept the binary 1's and 0's as the input prompt 64 (or as the multi-modal input prompt 72, when combined with the natural language query 76). The byte vocabulary expansion 62, in other words, starts from a different modality (e.g., binary 1's and 0's) than the modality originally expected by the large language model 60 (e.g., the natural language textual query 76).

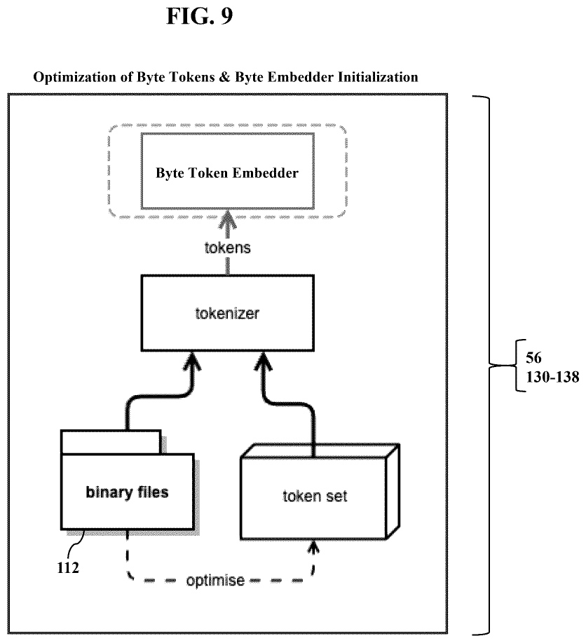

FIG. 9 is a simple architectural illustration of the byte tokenizer operation 134. The set of the byte tokens 132 is chosen from an underlying training dataset in a way that represents a suitable compromise between information retention and information compression. The latter information compression aspect may be needed, as even state-of-the-art LLMs may only process an information buffer of fixed length (context size) which is lower than the median size of the byte buffer 110 (illustrated in FIGS. 6-8) about which the large byte model 56 would be expected to reason. Once the byte tokens 132 have been chosen, an optional initialization step may ensue in which the byte token embedding 138 (i.e., a higher-dimensional representation) of each byte token 132 is established. In some examples, this byte token embedding initialization can be done by identifying tokens from the base large language model which constitute the byte tokens 132 and averaging their token embeddings 138. The byte token(s) 132 may serve as the input prompt 64 or multi-modal input prompt 72 to the large byte model 56 representing the large language model 60 trained using the byte vocabulary expansion 62 (as explained and illustrated with reference to FIGS. 2-8). This representation may be chosen using a mixture of the byte tokens 132 and byte token embeddings 138 (perhaps also including textual tokens and textual token embeddings used by the large language model 60) and show a proximity in meaning to the newly introduced byte tokens 132.

The byte tokenizer operation 134, as examples, may query a lookup table that maps, relates, or otherwise associates the unique byte token identifier 136 to each byte token 132 (such as a sequence of one (1) to N bytes) that a tokenizer training algorithm deems worth representing. When tokenizing a byte sequence, we employ methods of sub-word tokenization. These require delineating the token boundaries in a given byte sequence. This is a mathematical optimization problem, as there might be more than one way of stacking up the byte tokens 132 to arrive at the desired string. One possible algorithm is to start with the longest byte tokens 132 and replace any of their occurrences in the byte string to be encoded, then go down the byte tokens 132 in descending order of length. Such an algorithm may be applied during training as well as operation. This specific algorithm only serves as an example, since the Large Byte Model 56 can operate with any type of tokenization.

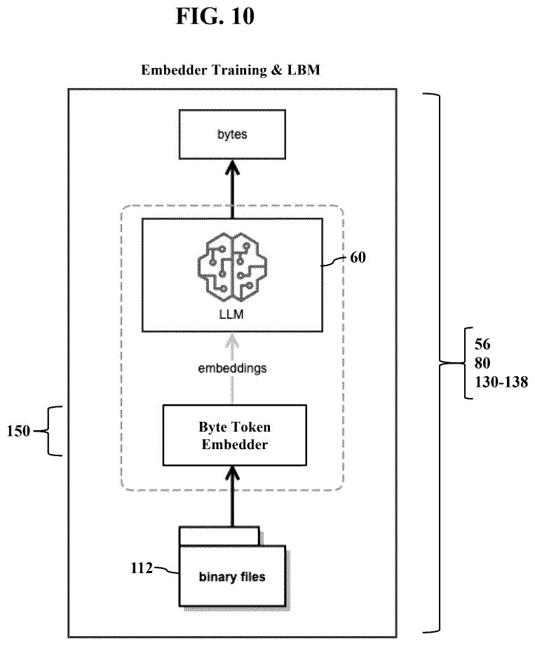

FIG. 10 is a simple architectural illustration of the next-byte token prediction operation 80. In order to ingest the vast amount of the cybersecurity binary data 102 (illustrated in FIGS. 3 & 6-7), which may contain both malicious and benign/normal samples, the large byte model 56 may implement an unsupervised next-byte prediction approach based on the byte tokens 132. A statistical distance measure (such as between the predicted next bits/bytes 54 and the true next byte(s), perhaps based on the input binary data set) may be used to optimize internal parameters associated with the large language model 60 and the byte token embedder 150. Due to the hierarchical nature of the large language model 60, the inventors currently believe that it may be advisable to partition the training into discrete steps which each only affect a subset of the LLM's hierarchies and the byte token embedder 150. This training partitioning may help to steer the training process into a direction in which the large byte model 56 retains the ability to reason sensibly about the text tokens included in its original, text-based token set. Indeed, in order to avoid catastrophic forgetting of previously learned concepts, the inventors are considering mixing natural language data together with byte data in this training step as well.

The byte-to-text associations 70 may be based on the byte tokens 132. The byte-to-text associations 70, for example, may relate a particular byte token 132 to its corresponding natural language explanation, meaning, definition, or other textual content. The byte-to-text associations 70, for example, may be configured as a token-to-text database that is locally or remotely accessible to the server 24. The token-to-text database, for example, may have columnar/row/tabular database entries that map, relate, or otherwise associate different byte tokens 132 to their corresponding natural language textual content. When the byte tokenizer operation 134 causes the server 24 to generate the byte token 132, the server 24 may query the byte-to-text associations 70 for the byte token identifier 136 and retrieve the corresponding natural language textual content. The server 24 and/or the large byte model 56 may thus identify and combine natural language textual content (such as the natural language output 66) in response to sequences of the byte tokens 132.

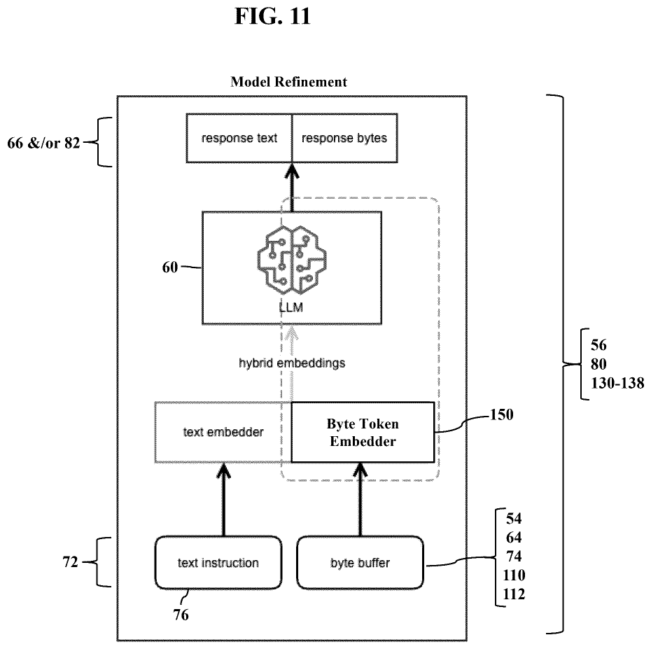

FIG. 11 is a simple architectural illustration of model refinement. In order to connect the large byte model's newly gained, implicit knowledge about byte information, some parameters of the large byte model 56 may be fine-tuned based on instruction-and-response pairs. Instruction and response data points both consist of corresponding text and 1/0 byte elements, where the text element describes the 1/0 byte element in a natural language fashion (such as the byte-to-text associations 70, as explained with reference to FIG. 2), perhaps also incorporating expert knowledge about the byte buffer 110. The inventors thus introduce binary/digital domain knowledge and terminology into the large byte model 56 without having to manually generate this information at the vast scale required to train the large language model 60 from scratch on a new set of tokens (such as the byte tokens 132). The large byte model 56 may thus attach or associate short, natural language descriptions of bits/bytes/sequences 54/74 (such as the byte-to-text associations 70). The large byte model 56 bridges the binary/digital language world with the English world of natural text. The large byte model 56 similarly implements self-referential byte-to-text associations 70, where the byte-to-text associations 70 explain each other and move from one byte to another.

The large byte model 56 may thus accept the natural language query 72/76. The user's multi-modal input prompt 76, for example, asks the large byte model 56 to interpret the byte buffer 110. The user, as examples, may ask “Does this sequence of bytes run on Windows, Mac, or Linux?,” “what is its computer behavior?,” and “what is the malware family?” The large byte model 56 then generates its natural language output 66 that bridges the byte and text worlds. The large byte model 56 may also generate an answer, though, with bytes of data. For example, the large byte model 56 may show or identify malicious 1's and 0's content (such as opening a port connection or socket for download of other malicious content). The large byte model 56 may thus generate multi-modal outputs that include text and binary data.

The large byte model 56 may thus be multi-modal. The large byte model 56 may accept (text+bytes) as the multi-modal input prompt 72 and generate multi-modal outputs (text+bytes, such as the natural language output 66, the byte description 92, the predicted next bits/bytes 54, and/or the predicted normal/abnormal operation 34/34, as explained with reference to FIGS. 2-3). The modalities of the input and output may thus differ, as the ith output token has to be generated from a mix of the byte tokens 132 and text tokens. For multi-modal models, conventional approaches have a modality-specific, pre-trained encoder, which generates embeddings that are fed into the LLM. This is especially needed since end-to-end training (on raw bytes) can be prohibitively costly. Additionally, in the byte space, the interesting information can be very sparse (such as relative to the full size of the byte buffer 110), so the large byte model 56 implements the byte tokenization 130 compressing/encoding the bits/bytes/sequences 54/74 into a fixed dimension.

The large byte model 56 thus revolutionizes binary assessment. The cybersecurity service 42 may incorporate the large language model 60 that already knows English. The cybersecurity service 42 may train the large language model 60 (using the cybersecurity binary data 102) to learn more about the sequences 74 of 1's and 0's. The cybersecurity binary data 102 may further include natural language descriptions of those 1's and 0's (such as the byte-to-text associations 70). One goal of the next-byte token prediction operation 80 is to make the large byte model 56 gain knowledge about the way the 1's and 0's are structured, but yet also to not make the large byte model 56 forget about its English knowledge. The cybersecurity service 42 may thus present binary 1/0 data to the large byte model 56, and the large byte model 56 generates a natural language summary of the binary/digital structure, behavior, and other functional descriptions/explanations. As very simple but useful examples, the large byte model 56 may identify the 1's and 0's as a WINDOWS® file, a MACOS® file, or a LINUX® file. The large byte model 56 may also identify the logical architecture. The large byte model 56 may further learn to predict the probable next bit/byte 82. The large byte model 56 may also summarize the originally-inputted bits/bytes/sequences 54/74 and the predicted next bit/byte 82. The large byte model 56 may also specifically reason and generate an event prediction, such as whether the originally-inputted 1's and 0's and/or the predicted next 1's and 0's is/are malicious or benign, or if traits indicate malicious activity. Indeed, the large byte model 56 may also identify and copy byte subsequences from the input 54/74 to the output to present the user with proof for why the assessment was malicious, if applicable. The cybersecurity binary data 102 may include richer datasets basically of the input prompts 64/72 and rich binary descriptions. The user of the large byte model 56 may thus enter broad questions (e.g., “summarize this byte sequence”) and large byte model 56 generates the natural language output 66 describing a summary of the binary input prompt 64 and its malicious activity.

The large byte model 56 works atop the large language model 60. There are many existing large language models 60, and each large language model 60 may have differing parameters, features, and performance. The large byte model 56, for example, may modify any CHAT GPT version using the byte vocabulary expansion 62. The large language model 60, though, may be chosen based on its knowledge of code programming. Some examples of the large language model 60, may include, but are not limited to: WizardCoder, StarCoder, and DeepSeekCoder. Whatever the large language model 60, though, the large byte model 56 represents the large language model 60 that is natively adapted to the bits/bytes/sequences 54/74 and the byte files 112 (illustrated in FIGS. 2-11). The large byte model 56 may thus adapt an off-the-shelf LLM to use the mixed next-byte/text prediction approach and trained on the vast dataset of the cybersecurity binary data 102 (illustrated in FIGS. 3 & 6-7). The large byte model 56 thus introduces and incorporates cybersecurity domain knowledge using combinations of bytes and text descriptions (e.g., the cybersecurity binary data 102 and the byte-to-text associations 70 illustrated in FIGS. 2-11).

The large byte model 56 thus greatly improves computer functioning. The large byte model 56 may identify and/or predict suspicious/malicious/abnormal operation 34. The large byte model 56, for example, may attribute a binary sample to the malware family 94 (such as ransomware, backdoor, rootkit, or other known/unknown malware). The large byte model 56, as another example, may explain the intent 96 of a binary, such as explaining function/code blocks. The large byte model 56 may also combine and explain function/code blocks representing a series of steps that the byte file 112 is taking. The large byte model 56 may thus explain binary content strings on a large scale that may replace a manual reviewing process. The large byte model 56, as another example, may retrieve deterministic descriptors of the byte file 112 (such as entropy, compile time, the digital signature/certificate 100, packing file utility from MacOS, file byte size, and architecture). The large byte model 56, as more examples, may de-obfuscate the byte file 112 and analyze damaged or packed files (such as heavily packed binaries, custom packers, Themida, MProtect, file format plugins failures, and other bugs). The large byte model 56, as more examples, may disassemble the byte file 112, inspect imported functions, debug a suspicious byte file 112, and identify bundled executables. The large byte model 56, as more examples, may identify historical byte-to-text associations 70 that recapture institutional cybersecurity knowledge and avoid repetitive, wasteful analysis. The large byte model 56, for example, may run cybersecurity tools (perhaps in a local virtual machine for reduced latency) and generate a report, perhaps even executing multiple byte files 112 and aggregating their results in an easy to view and share statistic. The large byte model 56, as another example, may issue added tokens that are interpreted by the cybersecurity service 42 to spawn a dedicated process (such as run tool X). The output can then be fed back into the large byte model 56 and the dialogue continues. The large byte model 56, as still more examples, may retrieve byte files 112 which show similar behaviors, thus aggregating similar types of behaviors from different files. The large byte model 56, as yet more examples, may understand binary formats and generate adversarial bytes (and perhaps their corresponding code).

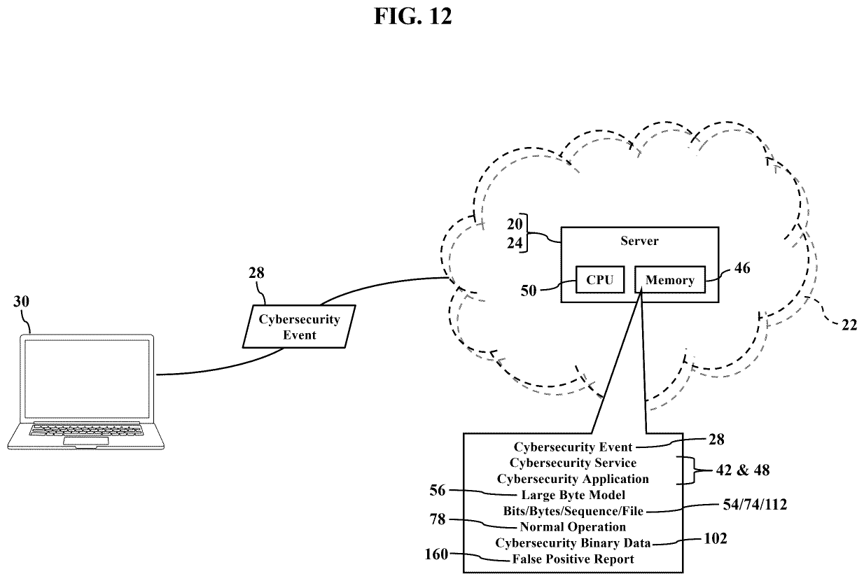

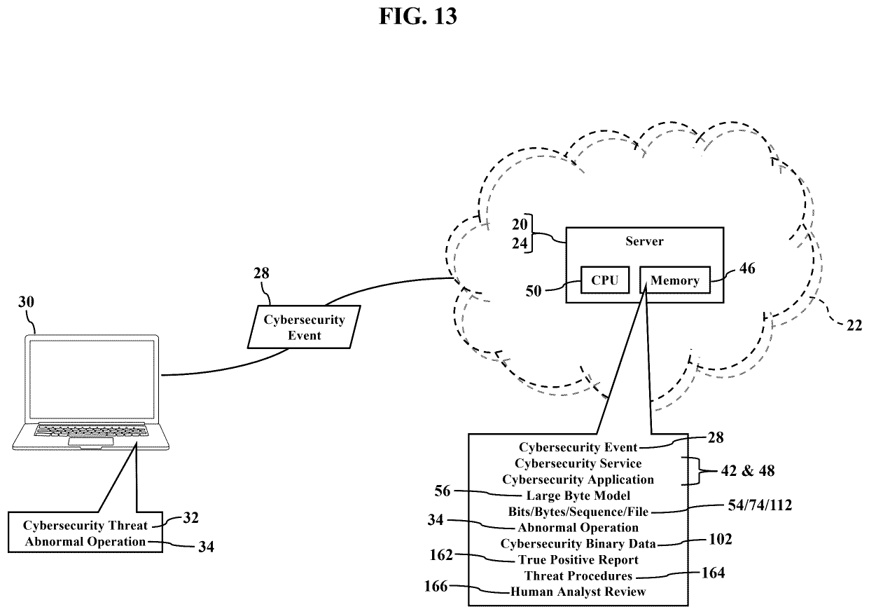

FIGS. 12-13 illustrate examples of true and false positives. The cybersecurity event 28 indicates that the client device 30 discovered some suspicious process, behavior, identity, location, or other data. The cybersecurity application 48 may thus send or apply the binary data (representing the cybersecurity event 28) to the large byte model 56 for analysis. The large byte model 56 may identify, or predict, that the binary data results in the safe or normal operation 78. The server 24 may thus generate an event prediction as an output, and the event prediction determines, or predicts, that the cybersecurity event 28 is actually the safe or normal operation 78. That is, even though the client device 30 reported the cybersecurity event 28 as possibly malicious computer behavior/activity, the large byte model 56 actually reveals that the byte content (e.g., the bits/bytes/sequences/file 54/74/112 representing the cybersecurity event 28) to be normal or harmless processes, behaviors, identities, locations, or other data. The bits/bytes/sequences/file 54/74/112, in other words, may match or resemble or represent historical benign cybersecurity binary data 102 that was used to train the large byte model 56. Because the cybersecurity event 28 may be statistically described as the normal operation 78, the cybersecurity application 48 may instruct the server 24 to label, sort, or classify the cybersecurity event 28 as a false positive report 160. The cybersecurity event 28, in simple words, is a false alarm. The cybersecurity application 48 may further label, sort, or classify the cybersecurity event 28 as benign, low priority, and/or not requiring further malware investigation. Urgent resources may thus be allocated to other, higher-priority detections.

As FIG. 13 illustrates, though, the cybersecurity event 28 may be a true positive report 162. When the large byte model 56 analyzes the cybersecurity event 28 (as instructed by the cybersecurity application 48), the large byte model 56 may determine, or predict, that the cybersecurity event 28 is suspicious/malicious/abnormal operation 34. The bits/bytes/sequences/file 54/74/112 representing the cybersecurity event 28, in other words, may resemble or match or represent historical suspicious/malicious/abnormal cybersecurity binary data 102 that was used to train the large byte model 56. The large byte model 56, however, may also flag or alert of novel, as yet unseen malicious bits/bytes/sequences/file 54/74/112. The cybersecurity event 28 may thus describe abnormal, anomalous, or perhaps even harmful processes, behaviors, identities, locations, or other data. The cybersecurity application 48 may further instruct the server 24 to label, sort, or classify the cybersecurity event 28 as the true positive report 162 of the suspicious/malicious/abnormal operation 34. The cybersecurity application 48 may further instruct the client device 30 to implement notification/quarantine/isolation/halt or other urgent threat procedures 164. The cybersecurity application 48 may also hand-off and queue the cybersecurity event 28 for a human analyst review 166 by cybersecurity subject matter experts. Because the cybersecurity event 28 has been screened and preliminarily assessed as the true positive report 162, the cybersecurity application 48 may route the cybersecurity event 28 to a human expert or group of human experts for an urgent, deep-dive analysis.

Computer functioning is greatly improved. Malicious software can ruin computer operations. The server 24 must quickly identify the abnormal operation 34 to minimize damage to the client computers 30. Because the cybersecurity application 48 utilizes the large byte model 56, the cloud-based cybersecurity service 42 accurately identifies malicious byte content. The server 24 need merely send the byte content representing the cybersecurity event 28 to the large byte model 56 for analysis. The large byte model 56 generates a fast malware determination, perhaps within seconds. The large byte model 56 may also generate a natural language explanation. The cloud-based cybersecurity service 42 is thus fast and simple, allowing the server 24 to quickly assess the thousands or millions of cybersecurity events 28 reported each week. The cloud-based cybersecurity service 42 thus greatly improves computer functioning of the server 24 when detecting malware.

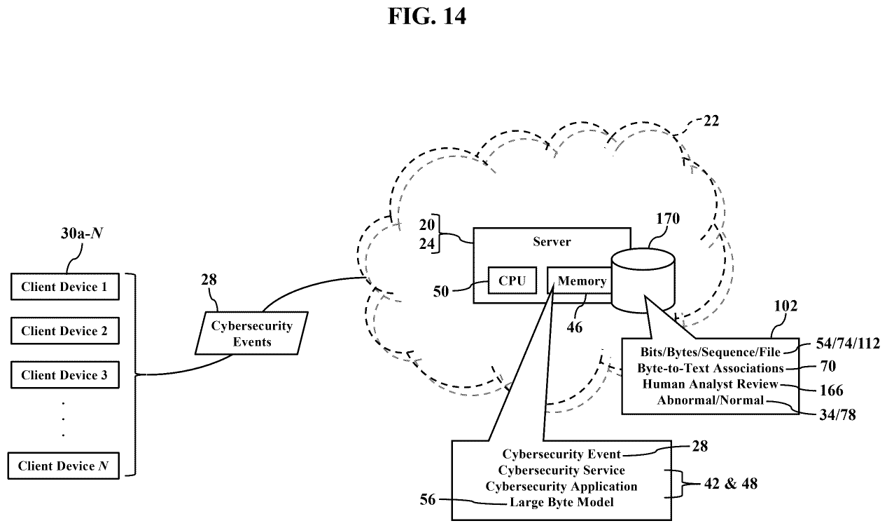

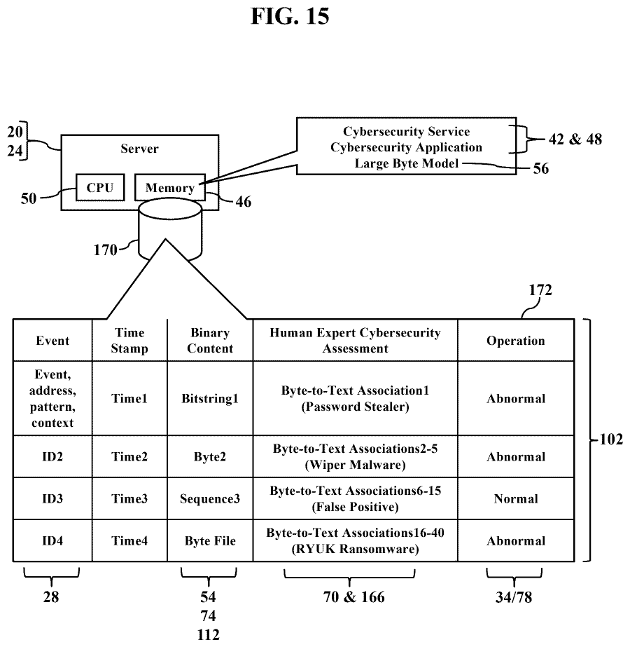

FIGS. 14-15 illustrate more examples of the cybersecurity binary data 102. The cybersecurity service 42 may collect, log, and retain many petabytes of the cybersecurity binary data 102. The cybersecurity binary data 102 may be collected over months and years of analyzing millions of cybersecurity events 28 and their corresponding 1's and 0's (e.g., the bits/bytes/sequences/files 54/74/112). The large byte model 56 may be trained using at least some of this rich cybersecurity binary data 102 reflecting vast quantities of historical cybersecurity expertise. As this disclosure above explained, every week the cloud computing environment 22 may receive thousands or millions of the cybersecurity events 28. The cybersecurity events 28 are sent by the client devices 30. While this disclosure only illustrates a few client devices 30, in actual practice there may be millions of client devices (illustrated as reference numerals 30a-N) reporting thousands of cybersecurity events 28 each week. Some of these cybersecurity event 28 may be scrutinized by human cybersecurity expert analysts. These human cybersecurity expert analysts may manually review part of the cybersecurity events 28. These human cybersecurity expert analysts may prioritize the review process and strive to not miss important malicious detections. The human cybersecurity expert analysts are specially-trained, subject matter experts in detecting the suspicious/malicious/abnormal operation 34. Over time, then, the human cybersecurity expert analysts may have labeled and classified millions of the cybersecurity events 28 using manual review or automated processes. The cybersecurity service 42 may thus leverage this rich and extensive cybersecurity knowledge as training data.

The cybersecurity service 42 may thus retain records of these human expert cybersecurity assessments. As the human cybersecurity expert analysts scrutinize up to thousands of weekly cybersecurity events 28 (e.g., the human analyst reviews 166), the cloud-based cybersecurity service 42 comprehensively stores and logs the details of each human expert cybersecurity assessment conducted by the human cybersecurity expert analysts. The cloud-based cybersecurity service 42 may thus retain vast amounts of institutional cybersecurity knowledge (such as the byte-to-text associations 70) developed over months/years by the human cybersecurity expert analysts. While any architecture or component may represent this historical cybersecurity expertise, FIG. 14 illustrates an electronic database 170 of the cybersecurity binary data 102. The electronic database 170 stores an electronic record of each cybersecurity event 28, its associated binary data (such as the bits/bytes/sequences/files 54/74/112), and the corresponding assessments (such as automated assessments and/or the human analyst reviews 166). The electronic database 170, in particular, may store electronic records logging different bits/bytes/sequences/files 54/74/112, their corresponding byte-to-text associations 70, and/or the corresponding normal/abnormal operation 34/78.

The cybersecurity service 42 thus maintains a vast and rich repository of historical cybersecurity knowledge. As the cloud computing environment 22 receives and assesses millions or billions of bits/bytes/sequences 54/74, the cloud computing environment 22 may collect and store records of the bits/bytes/sequences/files 54/74/112, their corresponding byte-to-text associations 70, and/or the corresponding normal/abnormal operation 34/78 to the electronic database 170. While the electronic database 170 may be remotely stored and accessed/queried from any networked location, for simplicity FIG. 14 illustrates the electronic database 170 as being locally stored in the memory device 46 of the server 24. Even though the electronic database 170 may have other logical structures, a relational database is perhaps easiest to understand. FIG. 15 thus illustrates the electronic database 170 as a table 172 having row and columnar database entries that map, relate, convert, or associate different parameters, elements, and other features of the cybersecurity binary data 102. As a simple example, FIG. 15 illustrates database entries that log different cybersecurity events 28, their corresponding timestamps, their corresponding bits/bytes/sequences/files 54/74/112, their corresponding byte-to-text associations 70 and other notes regarding the human analyst reviews 166, and their corresponding classification or label (such as normal/abnormal operation 34/78). As more and more bits/bytes/sequences/files 54/74/112 are analyzed, the cybersecurity application 48 may add database entries that log each new or different bits/bytes/sequences/files 54/74/112 and its data. The byte-to-text association(s) 70, as examples, may describe the corresponding process event(s), communication address(es), activities, behaviors, data values, bit patterns, and/or contextual login/location. Although not shown, the cybersecurity application 48 may further log and identify the names/identifiers of the human expert analyst(s) and his/her/their human expert cybersecurity assessment (again, perhaps as more byte-to-text association(s) 70). The electronic database 170 may thus log detailed notes or analysis used/applied by the human cybersecurity expert analyst(s) to assess the bits/bytes/sequences/files 54/74/112 representing the cybersecurity event 28.

The large byte model 56 may thus be trained using this vast and rich repository of cybersecurity binary data 102. The cloud-based cybersecurity service 42 leverages this rich and extensive malware knowledge developed by the best cybersecurity threat hunters. The electronic database 170 of cybersecurity events may be tapped to train the large byte model 56. The cybersecurity application 48, for example, may retrieve any of the database entries and use the database entries as cybersecurity training data to the large byte model 56. So, once the large byte model 56 is trained (such as explained with reference to FIGS. 8-11), the cybersecurity application 48 may utilize the large byte model 56 to analyze the current cybersecurity event 28 and to generate the event prediction. The large byte model 56 provides insight that distinguishes the false positive reports 160 from the true positive reports 162, perhaps at least partially based on the deep-dive historical analyses that human users provide. The large byte model 56, and thus the cybersecurity service 42, insightfully predicts whether the cybersecurity event 28 or other computer activity/behavior is malicious or not. The large byte model 56, however, may additionally reveal or predict the byte-to-text associations 70 explaining reactive or remedial actions. The cloud-based cybersecurity service 42 may thus automate the processing and handling of the cybersecurity events 28 and also reveal and highlight important detections related to particular threat actors. The cloud-based cybersecurity service 42 reflects vast amounts of institutional cybersecurity binary data 102. The institutional cybersecurity binary data 102 allows the cybersecurity service 42 to generalize to new cybersecurity threats that lie outside the existing cybersecurity binary data 102.

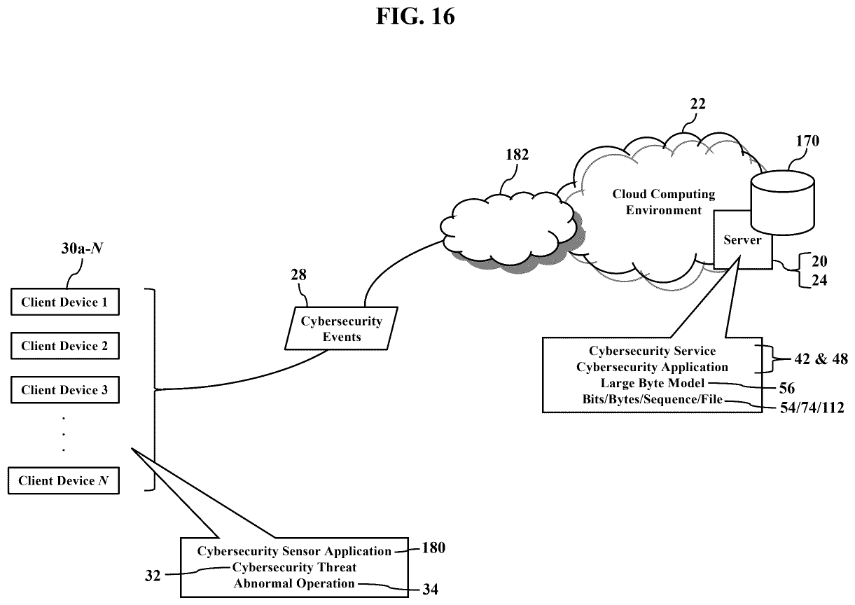

FIG. 16 illustrates more detailed examples of the cybersecurity events 28. While the cybersecurity application 48 may monitor any desired data, in these examples the cybersecurity application 48 monitors the cybersecurity events 28 reported by the client devices 30. Again, for simplicity, FIG. 16 only illustrates several client devices 30a-N. In actual practice, though, there may be thousands, or even millions, of the client devices 30 operating throughout the world. Each client device 30 downloads, stores, and executes a cybersecurity sensor application 180. The cybersecurity sensor application 180 is installed on the corresponding client device 30. The cybersecurity sensor application 180 thus includes computer program, code, or instructions that scan and monitor its corresponding client device 30 for events, communications, processes, activities, behaviors, data values, usernames/logins, locations, contexts, and/or patterns that indicate evidence of the malicious or abnormal operation 34. Should any cybersecurity sensor application 180 detect evidence of the cybersecurity threat 32 or abnormal operation 34 at the corresponding client device 30, the cybersecurity sensor application 180 instructs its client device 30 to generate and to report the cybersecurity event 28 to the cloud computing environment 22. The cybersecurity event 28 may include the bits/bytes/sequences/files 54/74/112 detected by the cybersecurity sensor application 180. The cybersecurity event 28 is routed via access/communications networks 182 to a network address (e.g., IP address) associated with the cloud computing environment 22. The cloud computing environment 22 may then route the cybersecurity event 28 to the network address (e.g., IP address) associated with the server 24 hosting or providing the cybersecurity service 42. The server 24 logs each cybersecurity event 28 in the electronic database 170. The cybersecurity event 28 may include a detailed description of the client device 30 (e.g., make, model, software and hardware inventory) and the events, communications, activities, behaviors, data values, and/or patterns that triggered reporting. The server 24 executes the cybersecurity application 48 and feeds the bits/bytes/sequences/files 54/74/112 (representing the cybersecurity event 28) to the large byte model 56 (as this disclosure above explains).

The cybersecurity sensor application 180 may monitor identity domains and sensory agent domains. The cybersecurity sensor application 180 monitors endpoint processes conducted by the client device 30. The client device 30, in simple words, may be performing/executing an unusual/suspicious process or attempting an unusual/suspicious event, communication, activity, behavior, command line, or data value. The cybersecurity sensor application 180, however, may also monitor identity and contextual indicators, such as login attempts (usernames, passwords, dates/times), webpage domains/requests, locations, IP addresses, and usage of software applications. The cybersecurity sensor application 180 may monitor and report any unusual or suspicious usage context for the cybersecurity service 42. The cybersecurity event 28 may thus include a contextual detection that describes any current, unusual, or suspicious identity or context. When the server 24 receives the cybersecurity event 28, the server 24 may log and store the bits/bytes/sequences/files 54/74/112 representing the cybersecurity event 28 to the electronic database 170. The cybersecurity application 48, in particular, may instruct the server 24 to add database entries that log the contextual detection in association with the corresponding columnar/row entries. The cybersecurity application 48 may additionally or alternatively instruct the server 24 to load/write the bits/bytes/sequences/files 54/74/112 to the byte buffer 110 (as explained with reference to FIGS. 6-11). The cybersecurity application 48, and/or the human cybersecurity expert analysts, may thus log and analyze contextual usage/identity/location data.

The cybersecurity sensor application 180 monitors the client device 30. The cybersecurity sensor application 180 interfaces with an operating system (not shown for simplicity) executed by the client device 30. The cybersecurity sensor application 180 is a software application or program code stored in a memory device (not shown for simplicity) of the client device 30 and executed by a hardware processor (not shown for simplicity) operating within the client device 30. The cybersecurity sensor application 180 may thus have permissions to monitor any kernel-level activity and/or any user-mode activity conducted by the client device 30 (such as any smartphone, laptop, tablet, server, switch, or other computer). Should the cybersecurity sensor application 180 detect any suspicious activity, the cybersecurity sensor application 180 cooperates with the operating system to generate and send the cybersecurity event 28 to the cloud computing environment 22.

The endpoint cybersecurity sensor application 180 may be an antimalware driver. The endpoint cybersecurity agent 180, for example, may have kernel-level components having kernel-level permissions to a kernel of the host client device's operating system. The endpoint cybersecurity agent 180 may additionally have user-mode components having user-level permissions to a user mode of the host client device's operating system. The endpoint cybersecurity agent 180 may include computer program, code, or instructions that scan and monitor the host client device's operating system for events, communications, processes, activities, behaviors, data values, usernames/logins, locations, contexts, and/or patterns. Because the endpoint cybersecurity agent 180 has kernel-level permissions, the endpoint cybersecurity agent 180 may monitor any kernel-level activity and/or any user-mode activity conducted by the client device 30. The endpoint cybersecurity agent 180 may register for and receive kernel-level notifications and call backs from the kernel.

Computer functioning is further improved. Each week the server 24 may receive thousands of cybersecurity events 28 reported by the millions of the cybersecurity sensor applications 180 operating in the field. The server 24 must very quickly assess each cybersecurity event 28 to prevent malware from damaging the client devices 30. The server 24 must further quickly assess each cybersecurity event 28 to stop the malware from spreading and infecting other machines. However, because the server 24 provides the fast and elegant cybersecurity service 42, the server 24 need only feed the bits/bytes/sequences/files 54/74/112 (representing the cybersecurity event 28) to the large byte model 56. The large byte model 56 quickly and easily assesses the bits/bytes/sequences/files 54/74/112 for the presence of malware.

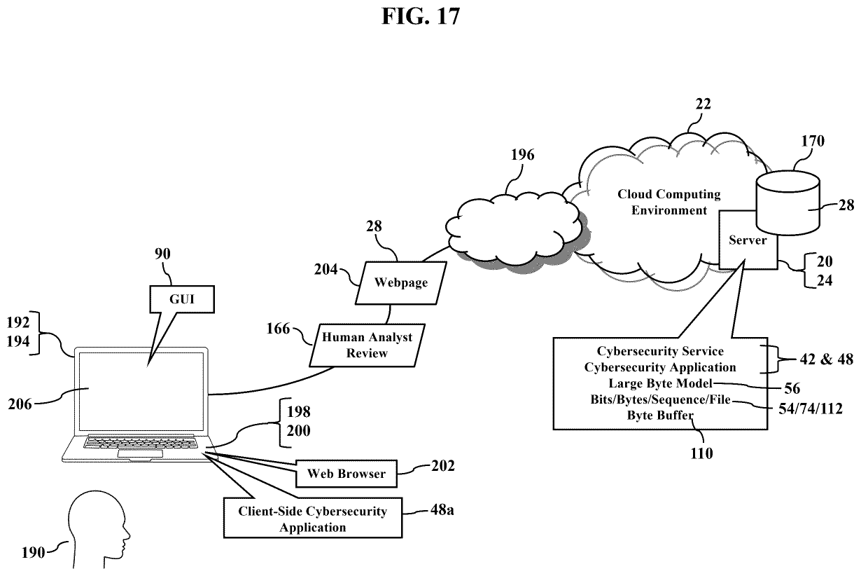

FIG. 17 illustrates some examples of remote access. When a user (such as the human cybersecurity analyst expert 190, an end user customer, or other cybersecurity/IT personnel) scrutinizes the cybersecurity event 28 and performs the human analyst review 166, the analyst's computer 192 may interface with the server 24. FIG. 17 illustrates the analyst's computer 192 as a remote laptop computer 194, but the analyst's computer 192 may be any smartphone, tablet, server, or other computer. The analyst's computer 192 has a network interface to an access network or other communications network 196, thus allowing the analyst's computer 192 to establish network communications with the cloud computing environment 22 and/or with the server 24. The analyst's computer 192 may thus have access permissions to the cloud computing environment 22 and/or to the server 24. The analyst's computer 192 has a hardware processor 198 that executes a client-side version 48a of the cybersecurity application stored in a memory device 200. The cybersecurity application 48 and the client-side version 48a may cooperate in a client-server relationship to facilitate the human analyst review 166 of the cybersecurity event 28.

While other mechanisms may be used, FIG. 17 illustrates examples using web pages. The analyst's computer 192 stores and executes a web browser 202 that interfaces with the client-side version 48a of the cybersecurity application. When the analyst/customer/user 190 conducts the human analyst review 166, the user commands the client-side version 48a of the cybersecurity application to establish communication with the server 24 and to access the electronic database 170 logging the cybersecurity event 28. The web browser 202 and the client-side version 48a cooperate to request and to receive a webpage 204 having electronic content representing the cybersecurity event 28 retrieved from the electronic database 170. The webpage 204, for example, may identify, explain, present, or otherwise represent the 1's and 0's representing the cybersecurity event 28. The analyst's computer 192 processes and displays the webpage 204 as the graphical user interface (GUI) 90 via a display device 206. The analyst/customer/user 190 may thus scrutinize the bits/bytes/sequences/files 54/74/112 (representing the cybersecurity event 28) and submit some or all of the bits/bytes/sequences/files 54/74/112 to the large byte model 56. The analyst/customer/user 190, as examples, may request (perhaps via the graphical user interface 90) that the server-side cybersecurity application 48 load the bits/bytes/sequences/files 54/74/112 into the byte buffer 110 and commence the assessment performed by the large byte model 56. When the large byte model 56 generates its output (such as the natural language output 66, the byte description 92, the predicted next bit/byte 82, and/or the event prediction, as illustrated in FIGS. 2-15), the cybersecurity application 48 may send a revised version of the webpage 204 having content representing the output. The analyst's computer 192 processes and displays the revised webpage 204, thus allowing the analyst/customer/user 190 to view the cybersecurity assessment performed using the large byte model 56. The analyst/customer/user 190 may further add or augment the output by typing/entering the human analyst review 166. The analyst's computer 192 and the server 24 may thus continue to cooperate and pass/send/exchange data (such as logging database entries to the electronic database 170).

FIG. 18 illustrates some examples of local analysis. Here the endpoint cybersecurity sensor application 180 (installed on the corresponding client device 30) may locally analyze its cybersecurity events 28. The cybersecurity sensor application 180, for example, may download the large byte model 56 to local memory (not shown for simplicity) of the client device 30. A hardware processor (not shown for simplicity) of the client device 30 may thus execute the endpoint cybersecurity sensor application 180. The client device 30 may thus be another example of the computer system 20 providing the cybersecurity service 42. The large byte model 56, as yet another example, may be pretrained (perhaps by the cloud computing network 22) and distributed to the client devices 30 operating in the field. Once the large byte model 56 is installed to the client device 30, the cybersecurity sensor application 180 may incorporate the large byte model 56 (perhaps as a software module or package update) that allows the cybersecurity sensor application 180 to locally and autonomously assess its cybersecurity events 28. The endpoint cybersecurity sensor application 180 may cooperate with the local host operating system to monitor the computer system 20 (such as the client device 30). The client device's operating system notifies the endpoint cybersecurity agent 192 of events, processes, API calls, machine data, and other computer activities/behaviors/contexts requested by locally-stored software applications. The endpoint cybersecurity sensor application 180 may then input or direct the bits/bytes/sequences/files 54/74/112 (representing the cybersecurity event 28) to the large byte model 56 (as this disclosure above explains). The cybersecurity sensor application 180 may thus use the large byte model 56 to verify unusual/suspicious processes, events, communications, activities, behaviors, command lines, or data values locally detected at the client device 30. The cybersecurity sensor application 180 may also instruct or cause the client device 30 to report its local analysis back to the cloud computing network 22.

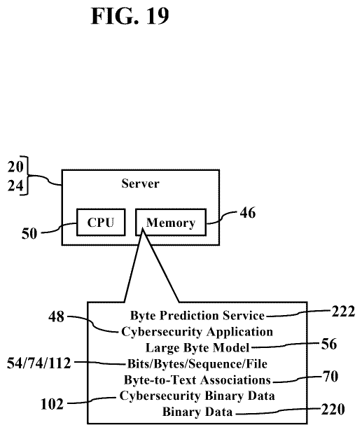

FIG. 19 illustrates examples of other particular solutions to particular problems. The large byte model 56 may be used to assess other bits/bytes/sequences/files 54/74/112. The large byte model 56, in other words, need not be exclusively trained only on the cybersecurity binary data 102. The large byte model 56, instead, may be trained using other or all binary data 220, regardless of industry or sector. Indeed, the large byte model 56 may be trained with strings/sequences of 1's and 0's representing some or all binary content (such as accounting, finance, engineering/science/research, production, quality control, human resources, sales/marketing, management, payroll, and service). The byte-to-text associations 70 may thus also be tailored to reference any computer operations and any terminology, regardless of industry or sector. The server 20 may thus provide a byte prediction service 222 that explains, simplifies, and demystifies bits/bytes/sequences/files 54/74/112, regardless of the industry or sector. Simply put, the large byte model 56 may be trained using millions, billions, or more of different bits/bytes/sequences/files 54/74/112. The cybersecurity application 48 and the large byte model 56 may accept all bits/bytes/sequences/files 54/74/112 and generate the natural language output 66 for some, most, or all binary content.

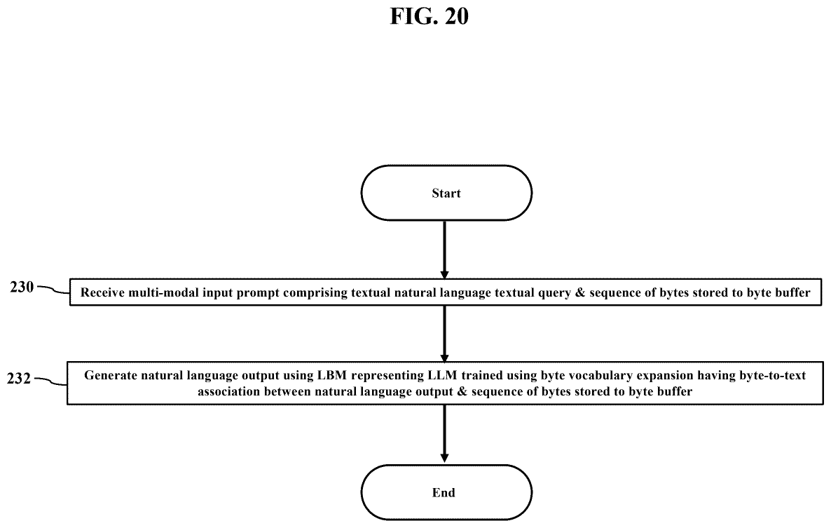

FIG. 20 illustrates examples of a method or operations executed by the computer system 20 that assess the bits/bytes/sequences/files 54/74/112. The computer system 20 receives the multi-modal input prompt 72 comprising the textual natural language query 76 and the sequence 74 of the bytes 52 stored to the byte buffer 110 (Block 230). The computer system 20 generates the natural language output 66 in response to the multi-modal input prompt 72 by using the large byte model 56 representing the large language model 60 trained using the byte vocabulary expansion 62 having the byte-to-text association 70 between the natural language output 66 and the sequence 74 of the bytes 52 stored to the byte buffer 110 (Block 232).

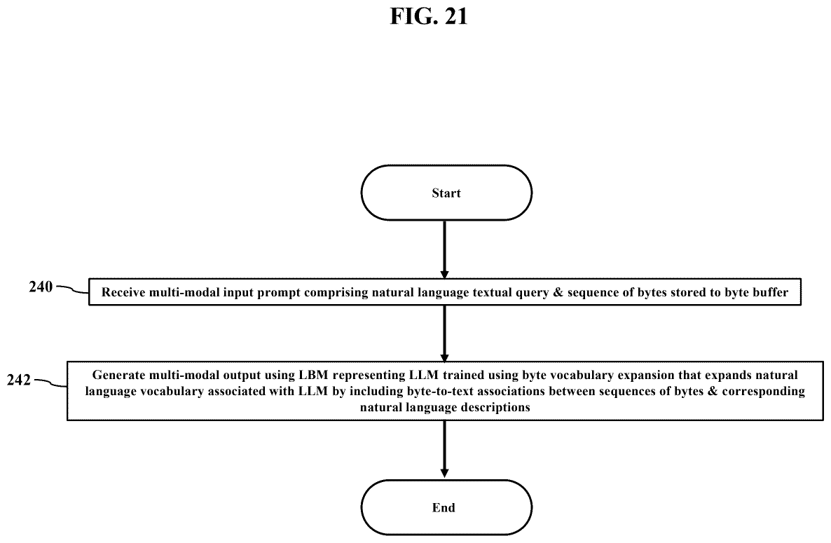

FIG. 21 illustrates examples of another method or operations executed by the computer system 20 that assess the bits/bytes/sequences/files 54/74/112. The computer system 20 receives the multi-modal input prompt 72 comprising the textual natural language query 76 referencing the sequence 74 of the bytes 52 stored to the byte buffer 110 (Block 240). The computer system 20 generates the multi-modal output 66 & 82 in response to the multi-modal input prompt 72 by using the large byte model 56 representing the large language model 60 trained using the byte vocabulary expansion 62 that expands the natural language vocabulary associated with the large language model 60 by including the byte-to-text associations 70 between sequences of bytes and their corresponding natural language descriptions (Block 242).

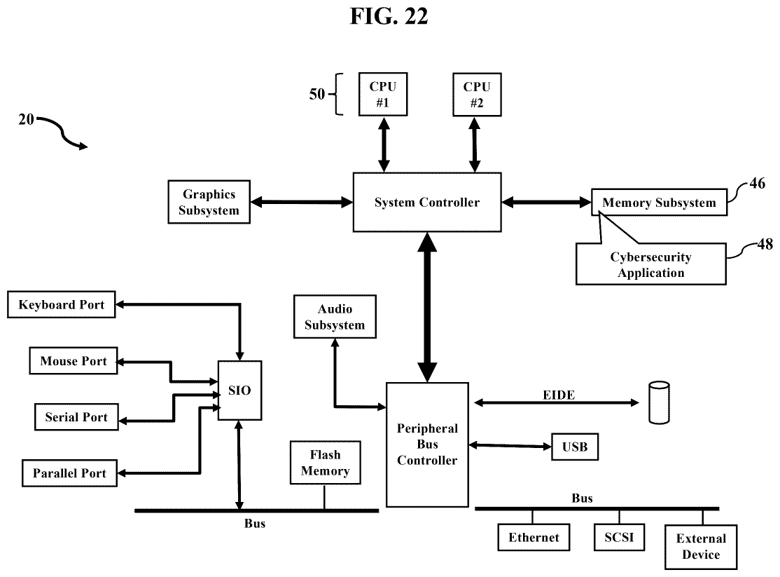

FIG. 22 illustrates a more detailed example of the operating environment. FIG. 22 is a more detailed block diagram illustrating the computer system 20. The cybersecurity application 48 is stored in the memory subsystem or device 46. One or more of the hardware processors 50 communicate with the memory subsystem or device 46 and execute the cybersecurity application 48. Examples of the memory subsystem or device 46 may include Dual In-Line Memory Modules (DIMMs), Dynamic Random Access Memory (DRAM) DIMMs, Static Random Access Memory (SRAM) DIMMs, non-volatile DIMMs (NV-DIMMs), storage class memory devices, Read-Only Memory (ROM) devices, compact disks, solid-state, and any other read/write memory technology.

The computer system 20 may have any embodiment. This disclosure mostly discusses the computer system 20 as the server 24 and as the client device 30. The cybersecurity service 42, however, may be easily adapted to mobile computing, wherein the computer system 20 may be a smartphone, laptop or desktop computer, a switch/router, a tablet computer, or a smartwatch. The cybersecurity service 42 may also be easily adapted to other embodiments of smart devices, such as a television, an audio device, a remote control, and a recorder. The cybersecurity service 42 may also be easily adapted to still more smart appliances, such as washers, dryers, and refrigerators. Indeed, as cars, trucks, and other vehicles grow in electronic usage and in processing power, the cybersecurity service 42 may be easily incorporated into any vehicular controller.

The above examples of the cybersecurity service 42 may be applied regardless of communications networking technology and networking environment. The cybersecurity service 42 may be easily adapted to stationary or mobile devices having wide-area networking (e.g., 4G/LTE/5G/6G cellular), wireless local area networking (WI-FI®), near field, and/or BLUETOOTH® capability. The cybersecurity service 42 may be applied to stationary or mobile devices utilizing any portion of the electromagnetic spectrum and any signaling standard (such as the IEEE 802 family of standards, GSM/CDMA/TDMA or any cellular standard, and/or the ISM band). The cybersecurity service 42, however, may be applied to any processor-controlled device operating in the radio-frequency domain and/or the Internet Protocol (IP) domain. The cybersecurity service 42 may be applied to any processor-controlled device utilizing a distributed computing network, such as the Internet (sometimes alternatively known as the “World Wide Web”), an intranet, a local-area network (LAN), and/or a wide-area network (WAN). The cybersecurity service 42 may be applied to any processor-controlled device utilizing power line technologies, in which signals are communicated via electrical wiring. Indeed, the many examples may be applied regardless of physical componentry, physical configuration, or communications standard(s).

Operating environments may utilize any processing component, configuration, or system. For example, the cybersecurity service 42 may be easily adapted to execute by a desktop, mobile, or server central/graphical processing unit 50 or chipset offered by INTEL®, ADVANCED MICRO DEVICES®, ARM®, APPLE®, TAIWAN SEMICONDUCTOR MANUFACTURING®, QUALCOMM®, or other manufacturer. The computer system 20 may even use multiple central CPUs/GPUs/cores or chipsets, which could include distributed processors or parallel processors in a single machine or multiple machines. The CPUs/GPUs/cores or chipsets can be used in supporting a virtual processing environment. The CPUs/GPUs/cores or chipsets could include a state machine or logic controller. When any of the CPUs/GPUs/cores or chipsets execute instructions to perform “operations,” this could include the CPUs/GPUs/cores or chipsets performing the operations directly and/or facilitating, directing, or cooperating with another device or component to perform the operations.

The cybersecurity service 42 may use packetized communications. When the computer system 20 and the cloud computing environment 22 communicate, information may be collected, sent, and retrieved. The information may be formatted or generated as packets of data according to a packet protocol (such as the Internet Protocol). The packets of data contain bytes of data describing the contents, or payload, of a message. A header of each packet of data may be read or inspected and contain routing information identifying an origination address and/or a destination address.

The cybersecurity service 42 may utilize any signaling standard. The cloud computing environment 22 may mostly use wired networks to interconnect the network members 26. However, the cloud computing environment 22 may utilize any communications device using the Global System for Mobile (GSM) communications signaling standard, the Time Division Multiple Access (TDMA) signaling standard, the Code Division Multiple Access (CDMA) signaling standard, the “dual-mode” GSM-ANSI Interoperability Team (GAIT) signaling standard, or any variant of the GSM/CDMA/TDMA signaling standard. The cloud computing environment 22 may also utilize other standards, such as the I.E.E.E. 802 family of standards, the Industrial, Scientific, and Medical band of the electromagnetic spectrum, BLUETOOTH®, low-power or near-field, and any other standard or value.

The cybersecurity service 42 may be physically embodied on or in a computer-readable storage medium. This computer-readable medium, for example, may include CD-ROM, DVD, tape, cassette, floppy disk, optical disk, memory card, memory drive, and large-capacity disks. This computer-readable medium, or media, could be distributed to end-subscribers, licensees, and assignees. A computer program product comprises processor-executable instructions for generating the natural language output 66 by using the large byte model 56 representing the large language model 60 trained using the byte vocabulary expansion 62, as the above paragraphs explain.

The diagrams, schematics, illustrations, and tables represent conceptual views or processes illustrating examples of cloud services malware detection. The functions of the various elements shown in the figures may be provided through the use of dedicated hardware as well as hardware capable of executing instructions. The hardware, processes, methods, and/or operating systems described herein are for illustrative purposes and, thus, are not intended to be limited to any particular named manufacturer or service provider.

As used herein, the singular forms “a,” “an,” and “the” are intended to include the plural forms as well, unless expressly stated otherwise. It will be further understood that the terms “includes,” “comprises,” “including,” and/or “comprising,” when used in this Specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

It will also be understood that, although the terms first, second, and so on, may be used herein to describe various elements, these elements should not be limited by these terms. These terms are only used to distinguish one element from another. For example, a first computer or container could be termed a second computer or container and, similarly, a second device could be termed a first device without departing from the teachings of the disclosure.

1. A method executed by a computer system for assessing a sequence of bytes, comprising:
receiving, by the computer system, a multi-modal input prompt comprising a textual natural language query and the sequence of bytes; and
generating, by the computer system, a natural language output in response to the multi-modal input prompt by using a large byte model representing a large language model trained using a byte vocabulary expansion having a byte-to-text association between the natural language output and the sequence of bytes.

2. The method of claim 1, further comprising training the large byte model representing the large language model using byte-to-text associations describing sequences of bytes.

3. The method of claim 1, wherein the byte-to-text association associates a byte token to at least a portion of the natural language output.

4. The method of claim 1, further comprising generating byte tokens by byte tokenizing the sequence of bytes.

5. The method of claim 4, further comprising generating byte token embeddings representing the byte tokens.

6. The method of claim 5, further comprising:
predicting a next byte associated with the sequence of bytes based on the byte token embeddings; and
predicting a malware based on the predicting of the next byte.

7. The method of claim 1, further comprising determining the sequence of bytes represents a normal operation or an abnormal operation based on the natural language output generated using the large byte model representing the large language model trained using the byte vocabulary expansion.

8. A computer system that assesses a sequence of bytes, comprising:
at least one central processing unit; and
at least one memory device storing instructions that, when executed by the at least one central processing unit, perform operations, the operations comprising:
receiving a multi-modal input prompt comprising a textual natural language query referencing the sequence of bytes; and
generating a natural language output in response to the multi-modal input prompt by using a large byte model representing a large language model trained using a byte vocabulary expansion having a byte-to-text association between the natural language output and the sequence of bytes.

9. The computer system of claim 8, wherein the operations further comprise generating a multi-modal output that predicts a byte in the sequence of bytes and that describes the sequence of bytes using the natural language output.

10. The computer system of claim 8, wherein the operations further comprise training the large byte model representing the large language model using byte-to-text associations describing sequences of bytes.

11. The computer system of claim 8, wherein the operations further comprise generating byte tokens by byte tokenizing the sequence of bytes.

12. The computer system of claim 11, wherein the operations further comprise generating byte token embeddings representing the byte tokens.

13. The computer system of claim 12, wherein the operations further comprise predicting a next byte associated with the sequence of bytes based on the byte token embeddings.

14. The computer system of claim 8, wherein the operations further comprise determining the sequence of bytes represents a normal operation or an abnormal operation based on the natural language output generated using the large byte model representing the large language model trained using the byte vocabulary expansion.

15. A memory device storing instructions that, when executed by a central processing unit, perform operations, comprising:
receiving a multi-modal input prompt comprising a textual natural language query referencing a sequence of bytes; and
generating a multi-modal output in response to the multi-modal input prompt by using a large byte model representing a large language model having a byte vocabulary expansion that expands a natural language vocabulary associated with the large language model by including byte-to-text associations between sequences of bytes and their corresponding natural language descriptions.

16. The memory device of claim 15, wherein the operations further comprise training the large byte model representing the large language model using the byte-to-text associations.

17. The memory device of claim 15, wherein the operations further comprise training the large byte model representing the large language model using the sequences of bytes and their corresponding natural language descriptions.

18. The memory device of claim 15, wherein the operations further comprise generating byte tokens by byte tokenizing the sequence of bytes.

19. The memory device of claim 18, wherein the operations further comprise generating byte token embeddings representing the byte tokens.

20. The memory device of claim 15, wherein the operations further comprise predicting a next byte associated with the sequence of bytes based on the byte token embeddings.
